(19) United States
(12) Patent Application Publication
(10) Pub. No.: US 2017/0009617 A1
(43) Pub. Date: Jan. 12, 2017

(54) SLEEVE VALVE ENGINE

(71) Applicant: TWO STROKE DEVELOPMENTS LIMITED, Middlesex (GB)

(72) Inventor: Paul Ellis, Greater London (GB)

(21) Appl. No.: 15/117,786

(22) PCT Filed: Feb. 11, 2015
(86) PCT No.: PCT/GB2015/050376

§ 371 Date: Aug. 10, 2016

(30) Foreign Application Priority Data
Feb. 11, 2014 (GB) 1402368.3

(51) Int. Cl. F01L 5/04; F01L 1/04; F02B 75/28; F02B 9/02; F02B 75/02

(52) U.S. Cl. CPC F01L 5/04; F02B 9/02; F02B 75/02; F02B 75/28; F01L 1/04; F02B 2075/025

(57) ABSTRACT

An engine comprises at least one cylinder, at least one piston reciprocatable within the at least one cylinder, at least one intake port through a wall of the at least one cylinder, at least one exhaust port through a wall of the at least one cylinder, at least one reciprocatable sleeve valve within the at least one cylinder for controlling porting of one or both of the at least one intake port and the at least one exhaust port, at least one shaft configured to be rotated by reciprocal motion of the at least one piston, a piston drive means coupled to and reciprocatable with the least one piston and a sleeve valve drive means coupled to and reciprocatable with the at least one reciprocatable sleeve valve. An axis of reciprocation the sleeve valve drive means is spaced from and parallel to an axis of reciprocation of the piston drive means of the at least one piston and the axis of reciprocation the sleeve valve drive means is positioned around the circumference of the shaft from the axis of reciprocation of the piston drive means of the at least one piston. This may allow the engine to be more compact and have a reduced physical size compared to some known engines.

### FIELD OF THE INVENTION

The invention relates to an engine having at least one piston arranged to reciprocate within at least one cylinder and at least one sleeve valve arranged to reciprocate within the same cylinder.

The invention also relates to an opposed piston engine in which a pair of opposed pistons is arranged to reciprocate in an opposed manner within a cylinder and at least one sleeve valve is arranged to reciprocate within the same cylinder.

### BACKGROUND TO THE PRESENT INVENTION

Engines comprising a reciprocatable sleeve valve positioned around a piston and arranged to reciprocate within a cylinder in which the piston reciprocates are generally known in the art.

United Kingdom patent application number GB1304458.1 relates to one typed engine comprising a sleeve valve. The engine is an opposed piston engine comprising at least one cylinder, at least two pistons reciprocatable within the same cylinder in an opposed manner, at least one intake port through the cylinder wall, at least one exhaust port through the cylinder wall, at least one shaft arranged to be rotated by reciprocal motion of the opposed pistons, at least one reciprocatable sleeve valve within the cylinder for controlling porting of one or both of the at least one intake port and the at least one exhaust port, a sleeve valve driving mechanism for controlling reciprocal motion of the at least one sleeve valve, and a dwell mechanism. The dwell mechanism is configured to induce at least one period of dwell of the at least two pistons during their respective cycles of piston motion.

The arrangement of the engine described in United Kingdom patent application number GB1304458.1 necessitates a certain physical size of the engine casing in order to accommodate the various internal engine components.

In recent years, there has been a trend in engine development towards downsizing, weight reduction and increased fuel economy. As such, there is a need for an improved engine which may have a reduced physical size and weight compared to known engines, such as the engine described in United Kingdom patent application number GB1304458.1.

There is also a general need for an engine capable of more efficient operation than known engines.

### SUMMARY OF THE INVENTION

In a first aspect, the present invention provides an engine comprising: at least one cylinder; at least one piston reciprocatable within the at least one cylinder; at least one intake port through a wall of the at least one cylinder; at least one exhaust port through a wall of the at least one cylinder; at least one reciprocatable sleeve valve within the at least one cylinder for controlling porting of one or both of the at least one intake port and the at least one exhaust port; at least one shaft rotatable by reciprocal motion of the at least one piston; a piston drive means coupled to and reciprocatable with the least one piston; a sleeve valve drive means coupled to and reciprocatable with the at least one reciprocatable sleeve valve; wherein the axis of reciprocation the sleeve valve drive means is positioned around the circumference of the at least one shaft from the axis of reciprocation of the piston drive means.

It will be appreciated that the piston drive means and the sleeve valve drive means piston drive means are spaced from one another around the at least one shaft. It will also be appreciated that the piston drive means reciprocates in a first space and the sleeve valve drive means reciprocates in a second space, the first and second spaces being positioned around the shaft from one another.

The offset positioning of the axis of reciprocation the sleeve valve drive means and the axis of reciprocation of the piston drive means may allow the engine to be more compact and have a reduced size and weight compared to some known engines.

Some preferred features of the invention in the first aspect are set out in the dependent claims to which reference should now be made. Some preferred features of the invention in the first aspect are also discussed below.

Preferably, an axis of reciprocation the sleeve valve drive means is spaced from, and parallel to, an axis of reciprocation of the piston drive means of the at least one piston.

Preferably, the axis of reciprocation the sleeve valve drive means is positioned about 90 degrees around the circumference of the at least one shaft from the axis of reciprocation of the piston drive means.

Preferably, the piston drive means is reciprocatable on a first plane and the sleeve valve drive means is reciprocatable on a second plane and the first plane is substantially orthogonal to the second plane.

Preferably, the timing of all exhaust porting events during the engine cycle is controllable independently of the position of the at least one piston within the at least one cylinder. Preferably, the timing of all intake porting events during the engine cycle is controllable independently of the position the at least one piston within the at least one cylinder. Preferably, the timing of all porting events (intake and exhaust) during the engine cycle is controllable independently of the position of the at least one piston within the cylinder.

Preferably, the engine further comprises a piston driving mechanism for engaging with the piston drive means and converting reciprocal motion of the at least one piston to rotational motion of the at least one shaft.

Preferably, the engine further comprises a sleeve valve driving mechanism for engaging with the sleeve valve drive means to reciprocate the at least one sleeve valve. Preferably, the sleeve valve driving mechanism converts rotational motion of the at least shaft to reciprocal motion of the at least one sleeve valve within the at least one cylinder.

Preferably, the engine is configured so that reciprocal motion of the at least one sleeve valve is linked to reciprocal motion of the at least one piston. This may allow the timing of reciprocal motion of the at least one sleeve valve to enter at the desired point in the cycle of reciprocal piston motion.

Preferably, the engine is configured so that the at least one sleeve valve is reciprocatable out of phase with the at least one piston. This may allow opening and closing of one or both of the at least one intake port and the at least one exhaust port to occur at the optimum point in the engine cycle and irrespective of the current position of the piston in the cylinder.

Preferably, the piston driving mechanism comprises a first cam mechanism comprising at least one piston cam.

Preferably, the sleeve valve driving mechanism comprises a second cam mechanism comprising at least one sleeve valve cam.

Preferably, the at least one piston cam comprises an axial cam. This may allow the engine to have a more compact configuration than some known engines.

Preferably, the at least one sleeve valve cam comprises an axial cam. This may allow the engine to have a more compact configuration than some known engines.

Preferably, the piston drive means comprises a piston rod assembly which extends from the at least one piston. The piston rod assembly is preferably coupled to the piston by a pin, which may be a gudgeon-type pin. The piston rod assembly may be used to guide and/or control movement of the at least one piston within the at least one cylinder. The piston rod assembly may also be used to prevent rotation of the piston within the at least one cylinder and/or rocking of the piston within the at least one cylinder.

Preferably, the piston rod assembly supports a first pair of cam followers. Preferably, the first pair of cam followers is rotatably supported by the piston rod assembly. The first pair of followers preferably engages with one or more cam surfaces of the at least one piston cam.

Preferably, the sleeve valve drive means comprises a sleeve valve driving arm which extends from the at least one reciprocatable sleeve valve. The sleeve valve driving arm preferably extends to a side of the reciprocatable sleeve valve. The sleeve valve driving arm preferably extends from the reciprocatable sleeve valve in the direction of a tangent to the reciprocatable sleeve valve.

The sleeve valve driving arm may be integrally formed with the sleeve valve. Alternatively, the sleeve valve driving arm may be attached, connected or coupled to the sleeve valve by any suitable means, for example by a suitable joining or welding process.

Preferably, the sleeve valve driving arm is attached, connected or coupled to the sleeve valve on an intersection between the first and second planes.

Preferably, the at least one sleeve valve comprises a flange around at least one end of the sleeve valve. The flange may limit travel of the piston within the cylinder. Preferably, the sleeve valve driving arm extends from, or is attached to the flange. The flange may stiffen the sleeve valve at the point of attachment of the sleeve valve driving arm.

Preferably, at least a portion of the sleeve valve driving arm comprises a substantially flat plate. The sleeve valve driving arm preferably has a generally triangular shape but may alternatively have another shape.

Preferably, the sleeve valve driving arm supports a second pair of cam followers. Preferably, the second pair of cam followers is rotatably supported by the sleeve valve driving arm. The second pair of followers preferably engages with one or more cam surfaces of the at least one sleeve valve cam.

Preferably an axis of reciprocation along which the first pair of followers reciprocate is positioned around the circumference of the shaft from an axis of reciprocation on which the second pair of followers reciprocate.

Preferably, the sleeve valve driving arm slidably engages with a slot in the cylinder. The slot may provide a sliding bearing surface for the sleeve valve driving arm. The slot may also prevent rotation of the sleeve valve within the cylinder. The slot may also constrain and/or limit the extent of sliding movement of the sleeve valve within and relative to the cylinder.

Preferably, the at least one piston cam is located on the at least one shaft. This may provide a more compact engine configuration than some known engines. It may allow reciprocal motion of the piston to be converted to rotational motion of the shaft without the need for an intermediate mechanism.

Preferably, the at least one sleeve valve cam is located on the at least one shaft. This may provide a more compact engine configuration than some known engines. It may allow reciprocal motion of the piston to be converted to rotational motion of the shaft without the need for an intermediate mechanism.

Preferably, the at least one piston cam is configured to induce at least one period of dwell of the at least one piston during its cycle of piston motion. This may improve the volumetric flow rate through, and subsequent efficiency of, the engine compared to some known engines.

Preferably, the at least one piston cam is configured to induce at least one period of dwell of the at least one piston in its BDC position during the cycle of piston motion. This may permit more complete scavenging of the waste products of combustion and may improve the volumetric flow rate through, and subsequent efficiency of, the engine.

Preferably, the at least one period of dwell of the piston in its BDC position is sufficient for the majority or substantially all of the process of scavenging of the waste products of combustion through the at least one exhaust port to occur before the at least one piston begins to move away from its BDC position. This may permit more complete scavenging of the waste products of combustion and may improve the volumetric flow rate through, and subsequent efficiency of, the engine compared to some known engines.

Preferably, the at least one piston cam is configured to induce at least one period of dwell of the at least one piston in its BDC position of between 60 and 140 degrees of rotation of the at least one shaft. Preferably, the at least one piston cam is configured to induce at least one period of dwell of the at least one piston in its BDC position of about 100 degrees of rotation of the at least one shaft.

Preferably, the at least one piston cam is configured to induce at least one period of dwell of the at least one piston in its TDC position during the cycle of piston motion. This may improve the volumetric flow rate through, and subsequent efficiency of, the engine compared to some known engines.

Preferably, the at least one period of dwell of the at least one piston in its TDC position is sufficient for substantially all of the heat exchange of combustion to occur in the cylinder at constant volume before the piston begins to move away from its TDC position. This may permit more complete combustion of fuel in the cylinder, thereby increasing the work done on the piston and the thermodynamic efficiency of the engine compared to some known engines.

Preferably, the at least one piston cam is configured to induce at least one period of dwell of the at least one piston in its TDC position of between 20 and 60 degrees of rotation of the at least one shaft. Preferably, the at least one piston cam is configured to induce a period of dwell of the at least one piston in its TDC position of about 40 degrees of rotation of the at least one shaft.

Preferably, the at least one sleeve valve cam is configured to induce at least one period of dwell of the at least one sleeve valve during its cycle of sleeve valve motion. This may permit any or all of the following benefits over some known engines: a greater period of time/number of degrees of shaft rotation for scavenging of the waste products of combustion; a greater period of time/number of degrees of shaft rotation for useful work to be done on the piston before the exhaust port is opened to allow scavenging; a greater period of time/number of degrees of shaft rotation for charging of the cylinder before the charge is compressed by the piston on its compression stroke; a greater period of time/number of degrees of shaft rotation for charge compression or ‘supercharging’ of the air entering the cylinder, for example by an external compressor; a greater period of time/number of degrees of shaft rotation for ‘blowdown’ to occur and allow the cylinder pressure to drop below the scavenging air pressure before charging of the cylinder. This may improve the volumetric flow rate through, and subsequent efficiency of, the engine.

Preferably, the at least one sleeve valve cam is configured to induce at least one period of dwell of the at least one sleeve valve in its TDC position during the cycle of sleeve valve motion. This may enable the combustion space to remain sealed for a greater period of time and/or greater number of degrees of shaft rotation and permit more complete combustion of fuel in the cylinder. This may improve the thermodynamic efficiency of the engine compared to the known engines.

Preferably, configured so that, in use, the at least one sleeve valve cam holds the at least one sleeve valve in its TDC position for a greater number of degrees of rotation of the shaft than the number of degrees of rotation of the shaft during which the at least one piston is held in its TDC position by the at least one axial sleeve valve cam. This may enable the combustion space to remain sealed for a longer period of time or greater number of degrees of shaft rotation and permit more complete combustion of fuel in the cylinder, even after the piston has set off on its expansion stroke towards its BDC position. This may improve the thermodynamic efficiency of the engine compared to some known engines.

The engine may be configured so that the axial piston cam is configured to induce at least one period of dwell of the at least one sleeve valve in its Bottom Dead Centre position during the cycle of sleeve valve motion.

Preferably, the at least one axial sleeve valve cam is configured to control porting of the at least one exhaust port and the engine is configured so that in use, the at least one exhaust port is opened by the at least one sleeve valve substantially as the at least one piston reaches its BDC position. Alternatively, the at least one axial sleeve valve cam may be configured so that in use, the at least one exhaust port is opened by the exhaust sleeve valve after the piston reaches its BDC position. Filter configuration may enable the exhaust ports to remain closed for a greater period of time/number of degrees of shaft rotation compared to some known engines and thereby allow work to be done on the piston over the entirety of the power or expansion stroke before the exhaust port is opened to permit scavenging.

Preferably, a plurality of intake ports is provided through the wall of the at least one cylinder. Preferably, a plurality of exhaust ports is provided through the wall of the at least one cylinder. This may increase the total area of the intake and exhaust ports compared to some known engines which have a single intake and/or exhaust port. Preferably, the total area of the intake ports is about the same as, or greater than, the area of the crown of the at least one piston. Preferably, the total area of the exhaust ports is about the same as, or greater than, the area of the crown of the at least one piston.

In a second aspect, the present invention provides an opposed piston engine comprising: at least one cylinder; at least two pistons reciprocatable in an opposed manner within the at least one cylinder; at least one intake port through a wall of the at least one cylinder; at least one exhaust port through a wall of the at least one cylinder; at least one reciprocatable sleeve valve within the at least one cylinder for controlling porting of one or both of the at least one intake port and the at least one exhaust port; at least one shaft rotatable by reciprocal motion of the at least two pistons; a piston drive means coupled to and reciprocatable with the least two pistons; a sleeve valve drive means coupled to and reciprocatable with the at least one reciprocatable sleeve valve; wherein the axis of reciprocation the sleeve valve drive means is positioned around the circumference of the at least one shaft from the axis of reciprocation of the piston drive means of at least one the at least two pistons.

Some preferred features of the invention in the second aspect are set out in the dependent claims to which reference should be made. Some preferred features of the invention in the second aspect are also discussed below.

Preferably, an axis of reciprocation the at least one sleeve valve drive means is spaced from and parallel to an axis of reciprocation of the piston drive means of at least one of the at least two pistons. Preferably, an axis of reciprocation the sleeve valve drive means is spaced from and parallel to an axis of reciprocation of the piston drive means of each of the at least two pistons.

Preferably, the axis of reciprocation the at least one sleeve valve drive means is positioned around the circumference of the at least one shaft from the axis of reciprocation of the piston drive means of each of the least two pistons.

Preferably, the axis of reciprocation the sleeve valve drive means is positioned about 90 degrees around the circumference of the at least one shaft from the axis of reciprocation of each of the at least two pistons.

Preferably, an axis of reciprocation of the piston drive means of a first one of the at least two pistons is positioned around the circumference of the at least one shaft from the piston drive means of a second one of the at least two pistons. Preferably, an axis of reciprocation of the piston drive means of the first one of the at least two pistons is positioned about 180 degrees around the circumference of the at least one shaft from the piston drive means of the second one of the at least two pistons.

Preferably, an axis of reciprocation of the at least one sleeve valve drive means is positioned around the circumference of the at least one shaft from, and is positioned between, the respective axes of reciprocation of the piston drive means of the first and second pistons.

Preferably, the at least two pistons are reciprocatable linearly and coaxially.

Preferably, the at least two pistons are reciprocatable in a synchronous manner.

Preferably, the engine further comprises at least two sleeve valves positioned within the same cylinder, one sleeve valve surrounding each of the at least two pistons, the sleeve valves being reciprocatable in an opposed manner within the at least one cylinder.

Preferably, the at least two sleeve valves are reciprocatable linearly, coaxially, and coaxially with the at least two pistons.

Preferably, the at least two sleeve valves are reciprocatable out of phase with one another. This may enable the timing of the opening and closing of the at least one exhaust port to be different from the timing of the opening and closing of the at least one intake port.

Preferably, the at least two sleeve valves are reciprocatable out of phase with their respective piston. This may enable the timing of the opening and closing of the at least one exhaust port and the at least one intake part to occur at different times to movement of the pistons.

Preferably, a first one of the at least two sleeve valves is arranged to control the porting of the at least one intake port and a second one of the at least two sleeve valves is arranged to control the porting of the at least one exhaust port. This may enable the timing of the opening and closing of the at least one exhaust port to be different from the timing of the opening and closing of the at least one intake port.

Preferably, the engine is configured so that in use of the engine, the at least one intake port is opened by the first sleeve valve about 20 degrees of rotation of the at least one shaft after the pistons reach their respective BDC positions.

Preferably, the engine is configured so that in use of the engine, the at least one exhaust port is closed by the second sleeve valve about 30 degrees of rotation of the at least one shaft after the pistons leave their respective BDC positions.

Preferably, the engine is configured so that in use, the at least one intake port is closed by the first sleeve valve about 50 degrees of rotation of the shaft after the pistons leave their respective BDC positions.

Preferably, the engine is configured so that in use, the at least one intake port is closed by the first sleeve valve about 20 degrees of at least one shaft rotation after the exhaust port is closed so as to enable pressure charging of the air entering through the at least one intake port.

Preferably, a plurality of intake ports is provided through the wall of the at least one cylinder at a location between the TDC and BDC positions of the first sleeve valve and a plurality of exhaust ports is provided through the cylinder wall at a location between the TDC and BDC positions of the second sleeve valve. This may enable the opening / closing of the intake ports to be controlled by the intake sleeve valve independently of, and at different points in the engine cycle to, the opening/closing of the exhaust ports by the exhaust sleeve valve.

In the first or second aspect of the invention, an intake tract leading to the at least one intake port may be bifurcated to allow streams of scavenging and charging air to be of separate origin, such as from a mechanical pump for scavenging air and from an exhaust turbocharger for charging air.

Preferably, in the first or second aspect of the invention, the at least one shaft is an output shaft for power take-off.

In one preferred form of the first or second aspect of the invention, the sleeve valve driving mechanism may be configured to open the at least one exhaust port through the cylinder wall substantially as the, or each, piston arrives at its respective BDC position. Alternatively, the sleeve valve driving mechanism may be configured to open the at least one exhaust port through the cylinder wall after the, or each, piston arrives at its respective BDC position. Either of these conditions may ensure that a maximum amount of work is done on the piston during the expansion stroke before the, or each, exhaust port is opened to allow scavenging of the combustion products from the cylinder.

In a further preferred form of the first or second aspect of the invention, the at least one reciprocatable sleeve valve may be a continuous (or non-ported) sleeve valve. This may help to prevent early opening of the at least one exhaust port and delay such opening of the at least one exhaust port until an end of the sleeve valve begins to move past the edge of the at least one exhaust port. It may also help to delay the closing of the at least one exhaust port.

In a further preferred form of the first or second aspect of the invention, the at least one sleeve valve is a continuous (or non-ported) sleeve valve and the sleeve valve driving mechanism is configured to open the at least one exhaust port through the cylinder wall substantially as, or after, the, or each, piston arrives at its respective BDC position.

In a further preferred form of the first or second aspect of the invention, the at least one sleeve valve is a continuous or non-ported sleeve valve and the sleeve valve driving mechanism is configured to open the at least one intake port through the cylinder wall after the, or each piston, has set off towards its respective TDC position.

The engine of the first and second aspects of the present invention is believed to have a number of advantages over some known engines, which may include some or all of the following, among others:

(i) reduced physical size, including in a length direction in which the at least one shaft extends;

(ii) reduced weight due to a more compact engine configuration resulting, for example, in a reduction in the physical size of an outer casing for the engine;

(iii) reduced inherent engine noise and reduced need for complex exhaust and silencing systems due to the provision of at least one sleeve valve for controlling porting of at least one of the at least one intake port and the at least one exhaust ports;

(iv) improved/inherent balancing of the engine;

(v) increased volumetric efficiency resulting from one or more of: a greater period of time/number of degrees of shaft rotation during which the at least one intake port is open to allow air to enter the cylinder; a greater period of time/number of degrees of shaft rotation during which the at least one exhaust port is open to allow scavenging of the cylinder; and a greater period of time/number of degrees of shaft rotation during which the at least one intake and exhaust port are open leading to improved airflow through the cylinders;

(vi) reduced soot formation due to an increase in the time available for combustion of fuel in the cylinder at constant volume;

(vii) reduced or eliminated side loads on the cylinder walls compared to rotary block engines;

(viii) ability to provide more ‘normal’/standard engine tolerances between moving components;

(ix) simpler lubrication and sealing between moving components.

An engine embodying the present invention may operate a two-stroke or four-stroke cycle. It is believed that the an engine embodying the present invention may provide the greatest volumetric efficiency gain over some known engines when operating a two stroke cycle and when compared with the efficiency attainable from known engines operating a two stroke cycle. The invention is particularly suited to a compression ignition international combustion engine operating a two-stroke cycle. The engine is also suitable for use as a two-stroke, spark or plasma ignition, internal combustion engine, among other types of engine.

The invention is believed to be suitable for use in a wide variety of applications including, but not limited to: land-based power generators; automotive applications, for example engines for use in land based vehicles including cars, motorcycles, lorries, trucks, railway locomotives, earth moving equipment and snowmobiles; marine applications, for example, outboard or onboard engines for boats; aviation applications, for example engines for use in light manned, aircraft or UAVs. Engines embodying the invention may also be used as the primary power/drive source in such applications or as one of the power/drive sources in a hybrid power/drive system.

The potential for the engine to have a reduced physical size compared to some known engines may make an engine embodying the invention particularly suitable for use in a motorcycle where the physical size and weight of the engine is particularly important.

Any feature in one aspect of the invention may be applied to other aspects of the invention, in any appropriate combination. In particular, any method aspects may be applied to apparatus aspects, and vice versa. Furthermore, any, some and/or all features in one aspect or embodiment may be applied to any, some and/or all features in any other aspect or embodiment, in any appropriate combination.

It should also be appreciated that particular combinations of the various features described and defined in any aspects of the invention can be implemented and/or supplied and/or used independently.

In the following description of preferred embodiments of the invention in the first and second aspects, the term “dwell” is used to refer to a period of rotation of the shaft during which the pistons remain stationary. “Dwell” is intended to refer to a period of stationary motion which is longer than the instantaneous moment at which reciprocating pistons in a conventional internal combustion engine (in which one or more pistons connected to conrods rotate a crankshaft) are stationary at their Top Dead Centre (TDC) and Bottom Dead Centre (BDC) positions.

In the following description of preferred embodiments of the second aspect of the invention: the term “transverse centreline” is used to refer to a line through the centre of the engine which is orthogonal to a rotational axis of the shaft and which extends horizontally through the centre of a combustion space defined between the piston crowns of the opposed pistons when in their Top Dead Centre (TDC) positions; the term “inner” is intended to mean being positioned closer to the transverse centreline of the engine and the term “outer” is intended to mean being positioned further from the transverse centreline of the engine.

### BRIEF DESCRIPTION OF THE DRAWINGS

Some example embodiments of the present invention will now be further described, by way of example only, with reference to the accompanying drawings, in which:

FIG. 1 is a perspective view of an engine embodying the present invention;

FIG. 2 is a further perspective view of the engine of FIG. 1 with a section of the engine casing removed;

FIG. 3 is an exploded view of the engine of FIGS. 1 and 2;

FIG. 4 is a section view through the engine of FIGS. 1 and 2 which has been sectioned along a length of the shaft;

FIG. 5 is a further section view through the engine of FIGS. 1 and 2 which has been sectioned along a length of the shaft;

FIG. 6 is a section view through the engine of FIGS. 1 and 2 which has been sectioned along a plane which is orthogonal to the shaft and which passes through a plurality of exhaust ports through a wall of the cylinder;

FIG. 7 is a further section view through the engine of FIGS. 1 and 2 which has been sectioned along a plane which is orthogonal to the shaft and which passes through a plurality of intake ports through a wall of the cylinder;

FIG. 8 is a perspective view of a pair of cylinders and their respective pistons and sleeve valves and associated drive mechanisms;

FIG. 9 is a view of the assembly of FIG. 8 with the cylinders removed to show two pairs of opposed pistons and sleeve valves and associated drive mechanisms;

FIG. 10 is an exploded view of the assembly of FIG. 9;

FIG. 11 is a perspective view of a shaft forming part of the engine of FIGS. 1 and 2;

FIG. 12 is further perspective view of a shaft forming part of the engine of FIGS. 1 and 2;

FIG. 13 is further perspective view of a shaft forming part of the engine of FIGS. 1 and 2 which has been sectioned along a length of the shaft;

FIG. 14 is an exploded view of a piston and sleeve valve assembly forming part of the engine of FIGS. 1 and 2;

FIG. 15 is a perspective view of a cylinder forming part of the engine of FIGS. 1 and 2;

FIG. 16 is a further perspective view of a cylinder forming part of the engine of FIGS. 1 and 2;

FIG. 17 is a view from the inside of a section of the casing of an the engine of FIGS. 1 and 2;

FIG. 18 is a section through the cylinder of FIGS. 15 and 16;

FIG. 19 is a section through an alternative form of an engine embodying the present invention at a point in the engine cycle during the period of dwell of the pistons at their TDC positions;

FIG. 20 is a further section through an alternative form of an engine embodying the present invention at a point in the engine cycle during a period of dwell of the pistons at their BDC positions with a plurality of intake port(s) fully covered by an intake sleeve valve and a plurality of exhaust port(s) partially uncovered by a exhaust sleeve valve;

FIG. 21 i is a further section through an alternative form of an engine embodying the present invention at a point in the engine cycle at which the pistons have arrived at their respective BDC positions, a plurality exhaust port(s) is uncovered by an exhaust sleeve valve at or near its BDC position and a plurality intake port(s) remains partially uncovered by the intake sleeve valve in which the engine is undergoing a period of blowdown;

FIG. 22 is a further section through an alternative form of an engine embodying the present invention at a point in the engine cycle at which the pistons are subjected to a period of dwell in their respective BDC positions, a plurality of exhaust port(s) is fully covered by a exhaust sleeve valve and a plurality intake port(s) is partially uncovered with the intake sleeve valve at or near its BDC position in which the engine is undergoing a period of supercharging;

FIG. 23 is a further section through an alternative form of an engine embodying the present invention at a point in the engine cycle during the compression stroke of the pistons with a plurality of exhaust port(s) fully covered by an exhaust sleeve valve and a plurality of intake port(s) partially uncovered by an intake sleeve valve; and

FIG. 24 is a diagram showing piston, exhaust sleeve valve and intake sleeve valve stroke position with degrees of shaft rotation during the cycle of an engine embodying the present invention.

### DETAILED DESCRIPTION OF PREFERRED EMBODIMENTS

An example embodiment of the present invention will now be described in detail with reference to the various figures. The engine of this embodiment is suitable for a wide range of applications and is particularly suitable as an engine for a motorcycle.

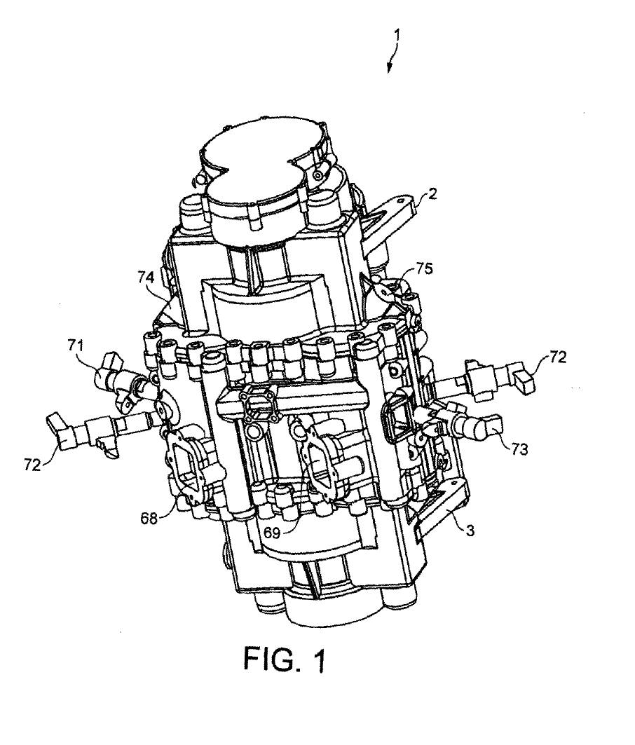

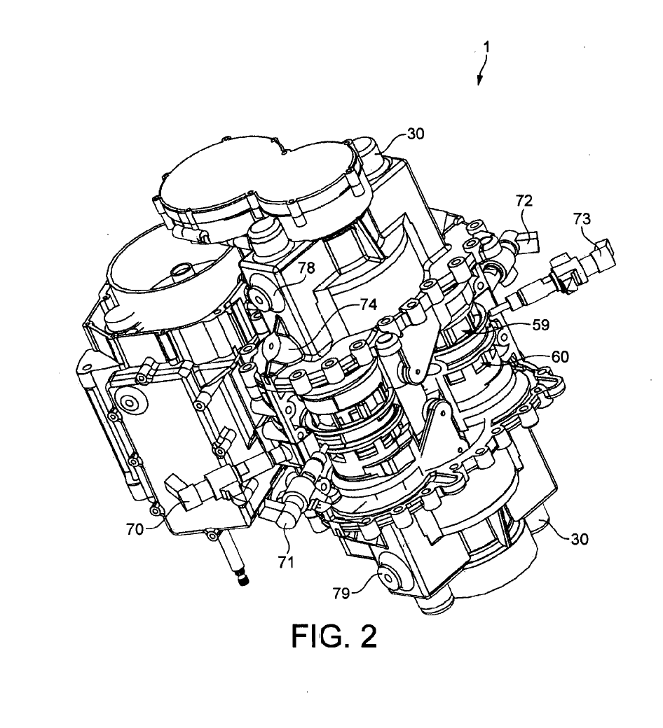

With reference to FIGS. 1 and 2, an engine 1 comprises a casing having a plurality of attachment points 2, 3 for attachment to a frame and/or another component of a powertrain system, such as a gearbox.

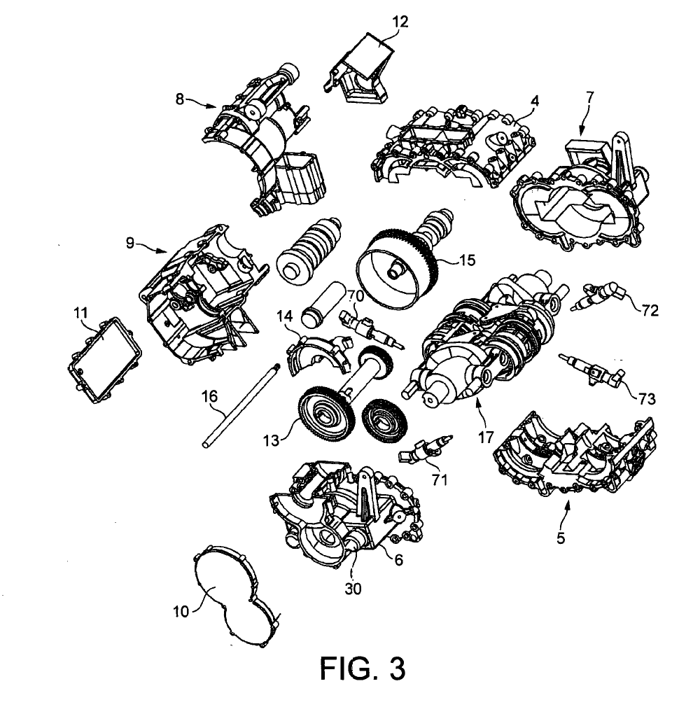

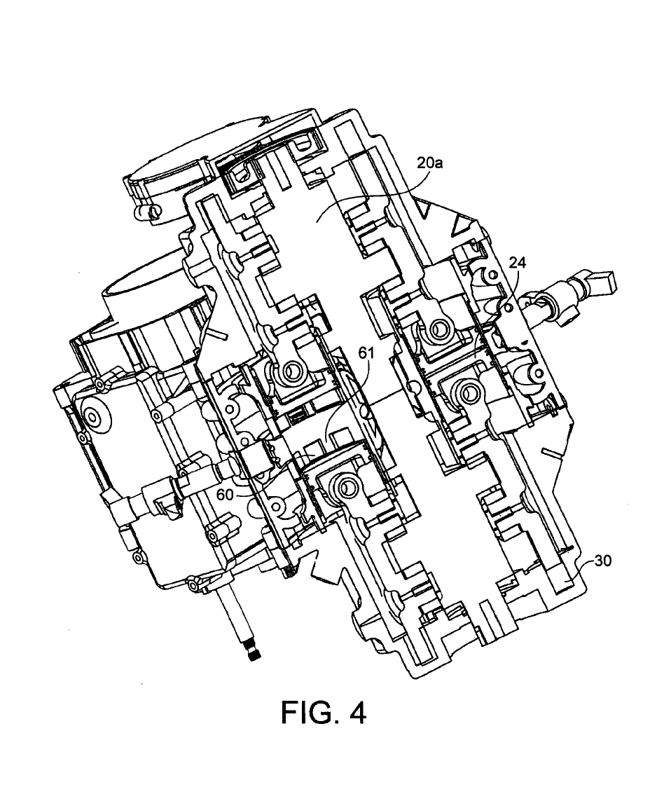

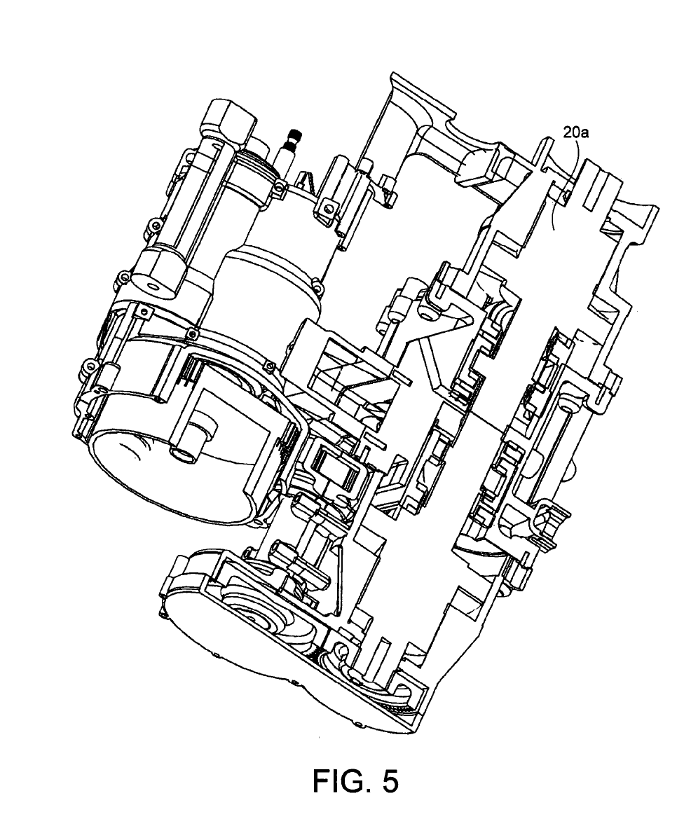

With reference to the exploded view of FIG. 3, the casing comprises a number of casing sections which facilitate assembly and disassembly of the engine, including: an induction or intake side casing 4; an exhaust side casing 5; a right hand end casing 6; and a left hand end casing 7. When the engine is combined with a gearbox, a gearbox top casing section 8 and a gearbox bottom casing section 9 may be provided. The right hand end casing section may include a removable end cap 10. The following may also be provided among other components:- an oil pan 11; a bracket for ancillaries 12 including pumps; an idler shaft 13; an idler shaft casing 14; a clutch housing 15 and a gear selector 16.

The various engine and gearbox casing sections may be affixed to one another using conventional fixing means. The engine casing may also be affixed to a frame or vehicle chassis (not shown) using conventional fixing means.

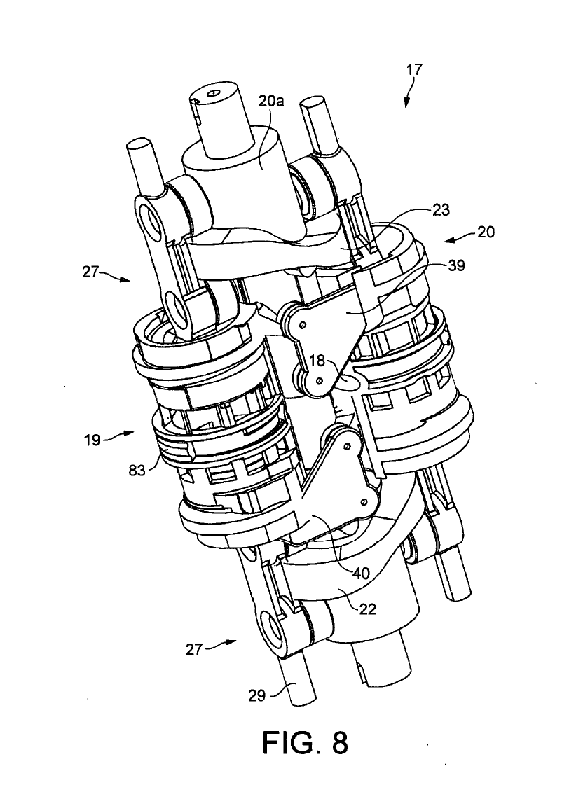

The casing houses a central drive assembly 17 shown generally in FIG. 8. The induction side casing section and the exhaust side casing sections may be affixed to one another using a pair of long bolts within sleeve valves which pass from the induction side casing 4 through the central drive assembly 17 to the exhaust side casing sections. The bolts within the sleeve valves may pass through notches or holes 18 in the central drive assembly to locate and prevent lateral or rotational motion of the central drive assembly. Removal of the bolts enables the induction side casing section and the exhaust side casing section to be separated, permitting access to the central drive assembly.

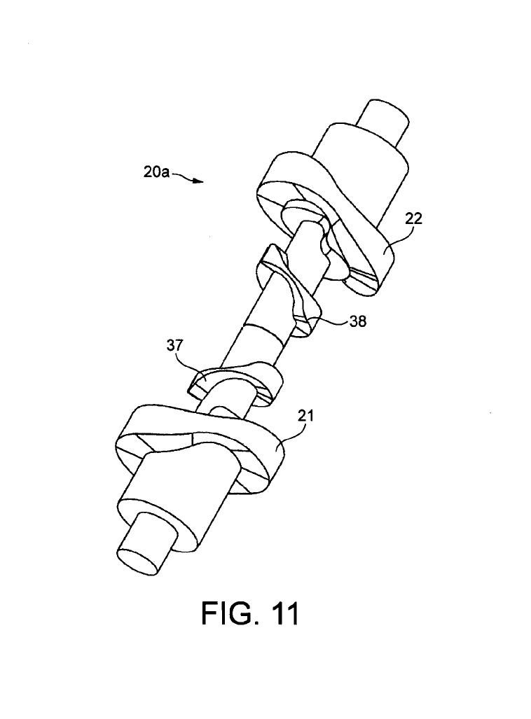

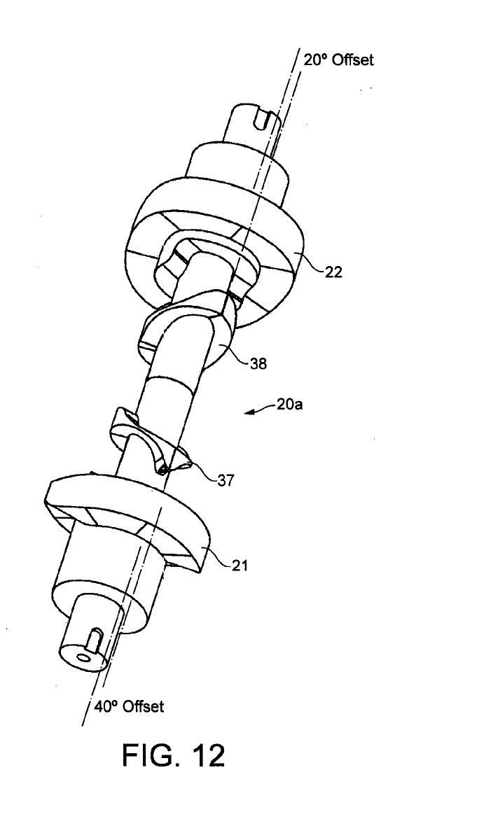

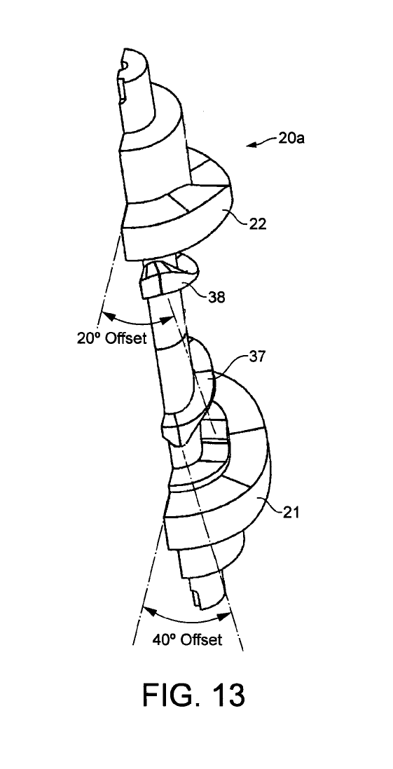

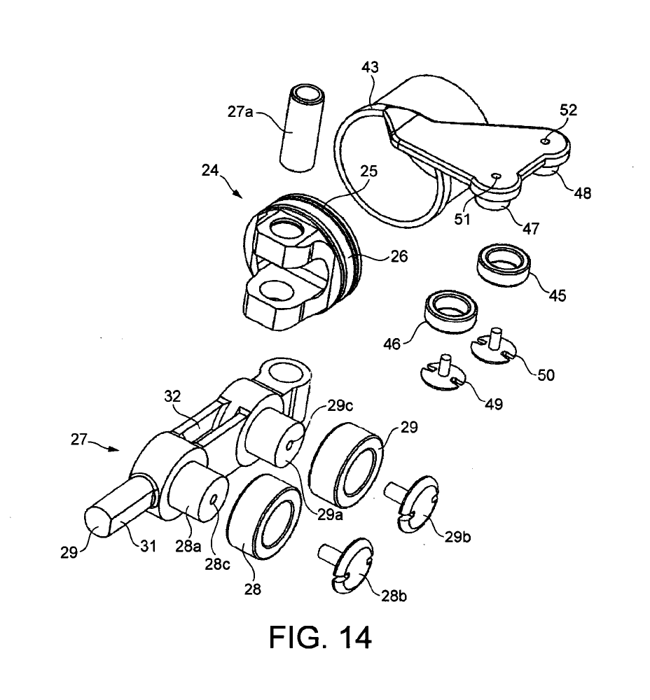

With reference to FIGS. 8 to 18, the central drive assembly includes a pair of cylinders 19, 20. A pair of opposed pistons is reciprocatable linearly and coaxially within each cylinder between respective Top Dead Centre (TDC) positions in which the piston crowns of the opposed pistons are substantially adjacent one another and respective Bottom Dead Centre (BDC) positions in which the piston crowns of the opposed pistons in each cylinder are spaced from one another.

The piston crowns may be provided with a concave depression or bowl to provide a combustion space. The pistons may also be provided with a squish band to promote turbulent flow of air or air and fuel entering the combustion chamber.

An elongate shaft 20a is positioned between the two cylinders. A rotational axis of the shaft is spaced from, and parallel to, an axis of reciprocation of the pistons in each cylinder. The shaft is rotationally supported in the cylinder block with suitable bearings. The shaft may also be sealed using appropriate seals. The ends of the shaft may be splined for connection to a gear or belt drive system. As will be described in more detail below, the engine is configured so that linear reciprocation of the opposed pairs of pistons within their respective cylinders resulting from the combustion of fuel/air mixture in the cylinders is converted to rotational motion of the central shaft 20a.

The engine includes a piston driving mechanism for converting reciprocal motion of the opposed pairs of pistons within their respective cylinders to rotational motion of the central shaft and for controlling reciprocal motion of the pistons. The piston driving mechanism is a cam mechanism. As shown in FIGS. 8 to 12, the cam mechanism includes a pair of spaced apart axial cams 22, 23 arranged on the shaft, one positioned closer to a left hand end of the engine and the other positioned closer to a right hand end of the engine. As shown in FIG. 8, the cams are preferably positioned outside of the outer ends of the cylinders.

The axial cams 22, 23 may be integrally formed with the shaft 20a. Alternatively, the cams may be provided on cam units or assemblies which may be formed integrally with the shaft or which may be splined for engagement with corresponding splines on the shaft. Each axial cam has inner and outer cam surfaces. The cam surfaces may be formed as shown by a single projecting flange projecting from the shaft. Alternatively, the cam surfaces may be formed by a pair of spaced, parallel, flanges projecting from the body of the cam, or a groove or channel within the body of the cam.

Each of the pistons 24 has one or more piston rings 25 towards the inner of the piston and an oil scraper ring 26 towards the outer end of the piston for reducing or eliminating the flow of oil around the piston and into the combustion space.

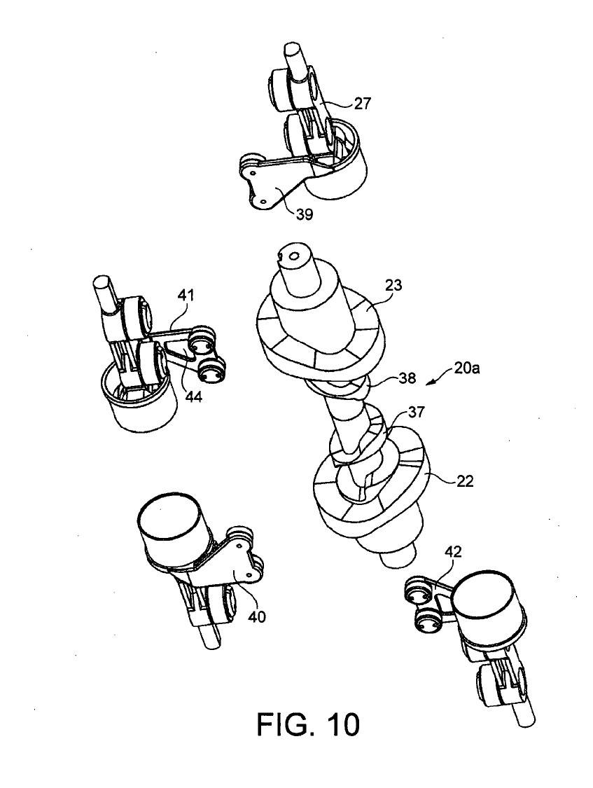

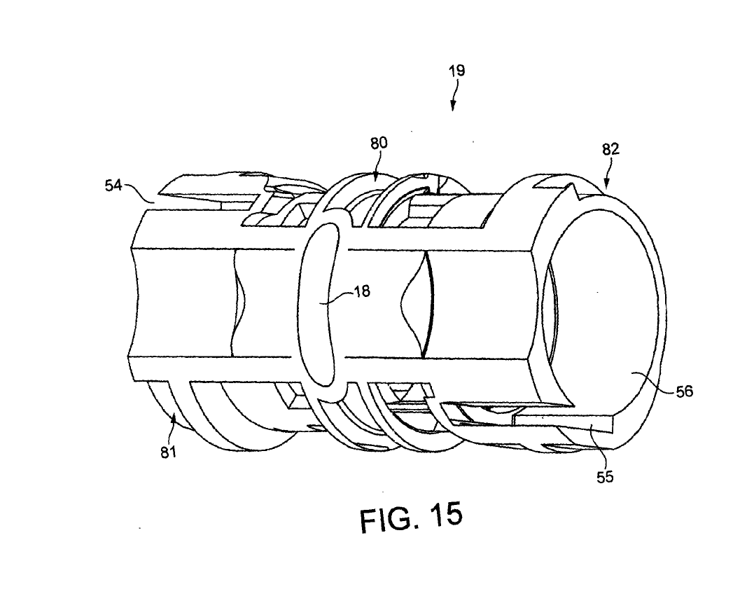

As shown in more detail in FIGS. 10 and 15, each of the pistons is provided with an extension portion or piston rod assembly 27 coupled to the piston by a transverse gudgeon-type pin 27a. A pair of followers in the form of rollers 28, 29 are rotatably supported by each piston rod assembly. The followers rotate around shoulders 28a, 29a which project from the piston rod assembly. The followers are located by threaded end caps 28b, 29b which engage with threaded holes 28c, 29c through the sleeve valve driving arms. The followers are positioned so they bear against the inner and outer cam surfaces of an associated axial piston cam. The respective pairs of followers of an adjacent pair of pistons on opposite sides of the shaft 20a act on opposite sides of the same axial piston cam. Each transversely adjacent pair of pistons is therefore configured to engage with and rotate the same cam.

Each of the piston rods may be provided with a pin 29 projecting from the outer end of the piston rod which is arranged to slide within a cylindrical slot or blind hole in the casing 30. The pin 29 may be provided with a flat portion 31 or groove to prevent hydraulic lock. The pin may help to stabilise the piston and prevent rocking of the piston within the cylinder during reciprocal motion. The blind hole and/or the pin may be lined or coated with a suitable friction reducing material. The piston rod assemblies may include a hole or depression 32 for weight reduction.

The profile of the axial piston cams 22, 23 may be adjusted during manufacture so as to define and control the desired pattern of reciprocal motion of the pistons. The axial cams may, for example, be shaped so that the opposed pistons in one of the cylinders are reciprocated in or out of phase with the opposed pistons in the other cylinder or so that, in each cylinder, the opposed pistons are reciprocated in or out of phase with each other.

Each of the cylinders 19, 20 is further provided with a pair of opposed sleeve valves 33, 34 and 35, 36 which act as sleeve valves for opening and closing intake and/or exhaust ports. The sleeve valves are positioned around the pistons and within the cylinders. One sleeve valve surrounds each of the opposed pistons in each cylinder. The sleeve valves in each cylinder are arranged to reciprocate in an opposed manner, coaxially with one another and coaxially with the axis of reciprocation of the opposed pistons. During the engine cycle, the pistons reciprocate within the sleeve valves and the sleeve valves reciprocate within the cylinders. Each piston reciprocates within the envelope of its respective reciprocating sleeve valve and each reciprocating sleeve valve reciprocates within the envelope of the cylinder.

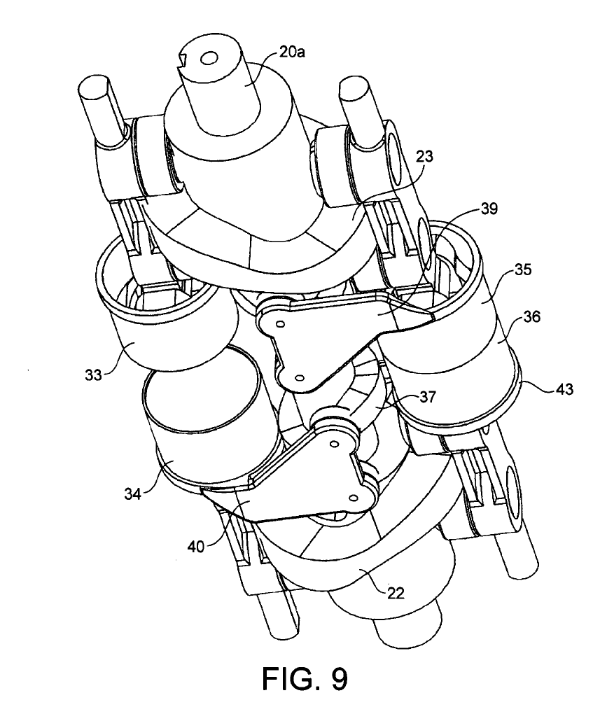

The sleeve valves are reciprocatable between respective TDC positions in which the sleeve valves are substantially adjacent one another and BDC positions in which the sleeve valves are spaced from one another (FIG. 9). In their respective TDC positions, the sleeve valves may be closer together than the pistons. In their TDC positions, the sleeve valves may abut or substantially abut one another so as to provide a sealed combustion chamber. The sleeve valves may alternatively abut, or substantially abut, a shoulder 33 protruding into the cylinder from the internal wall of the cylinder. The sleeve valves may be provided with flat, angled or profiled inner ends.

As will be described further below, the sleeve valves are used to control porting of the engine and enable the intake and exhaust porting to be controlled independently of the position of the pistons within the cylinders.

A sleeve valve driving mechanism is provided for reciprocating the sleeve valves within their respective cylinders. The sleeve valve driving mechanism comprises a further pair of axial cams 37, 38 positioned on the central shaft between the cylinders. One axial cam is provided on each side of the transverse centreline of the engine, one cam for each transversely adjacent pair of sleeve valves on opposite sides of the shaft 20a. The sleeve valve cams are be positioned on the central shaft, between the axial piston cams 22, 23. The sleeve valve cams may alternatively be positioned outside of the piston cams.

As described above in relation to the axial piston cams 22, 23, the axial sleeve valve cams 37, 38 may be integrally formed with the shaft or splined for engagement with corresponding splines on the shaft to permit removal for repair, modification and/or replacement. The sleeve valve cams may alternatively be formed on cam units assemblies which may be integrally formed with the shaft or splined for engagement with corresponding splines on the shaft.

As shown in more detail in FIGS. 9, 10 and 15, each sleeve is provided with a sleeve valve drive means 39, 40, 41, 42. The sleeve valve drive means is a sleeve valve driving arm which extends to a side of the sleeve valve in the direction of a tangent to the sleeve valve.

Each of the sleeve valves is provided with a flange 43 around its outer end. As will be described below, the flange may be used to limit travel of the piston within its respective cylinder. The sleeve valve driving arm preferably extends from the flange. The flange stiffens the sleeve valve at the point of attachment/connection of the sleeve valve driving arm.

The sleeve valve driving arm may be integrally formed with the sleeve valve. Alternatively, the sleeve valve driving arm may be attached, connected or coupled to the sleeve valve by a suitable means, for example by a suitable form of joining or welding process. The sleeve valve driving arms may include a hole or depression 44 for weight reduction.

Each sleeve valve driving arm comprises a substantially flat plate. The plate is generally triangular in shape and widens from the point of attachment with the flange towards the shaft. A pair of cam followers 45, 46 is rotatably supported by the flat plate. The followers bear against the inner and outer cam surfaces of the axial sleeve valve cams 37, 38. The followers, in the form of rollers, rotate around shoulders 47, 48 which project from the sleeve valve driving arm. The followers are located by threaded end caps 49, 50 which engage with threaded holes 51, 52 through the sleeve valve driving arms.

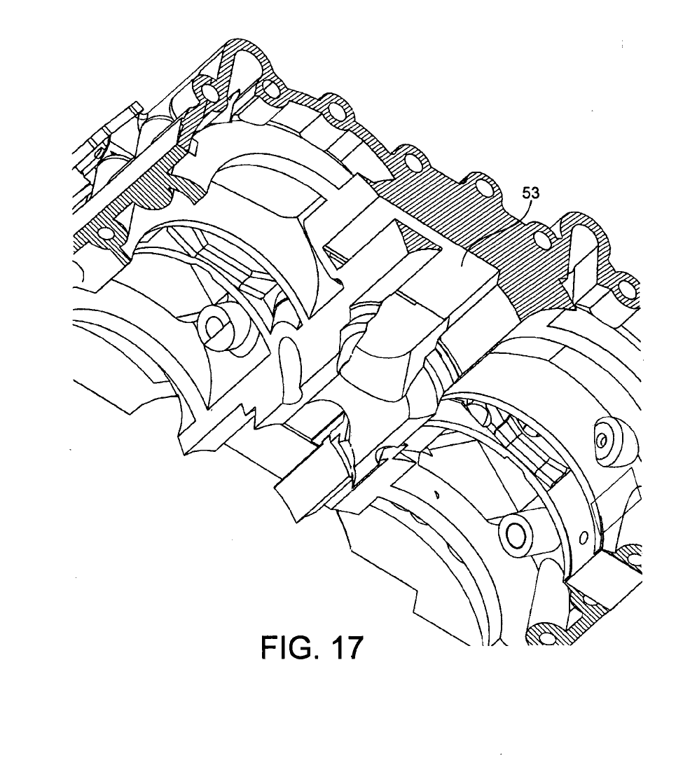

As shown in FIG. 17, bearing surfaces 53 may be provided on the inside of the engine casing for sliding engagement with each sleeve driving arms. This prevents rotation of the sleeve valves within the cylinders.

The cylinders are shown in more detail in FIGS. 15 to 18. Each cylinder 19, 20 is a generally elongate, hollow, body which surrounds the opposed pistons and sleeve valves. Each cylinder is formed with a slot 54, 55 at each end for receiving the sleeve valve driving arms of the opposed sleeve valves. The sleeve valve driving arms reciprocate within their respective slots. The slot may be lined with a bearing material or coating to reduce friction. The slots prevent rotation of the sleeve valve relative to the shaft. The slots also constrain and/or limit sliding movement of the sleeve valve within and relative to the cylinder.

Each cylinder may be provided with a stepped internal wall 56. This accommodates the different diameters of the main body of the sleeve valves and the flange for supporting the sleeve valve driving arm. The stepped internal wall may also define a limit of reciprocal motion of the sleeve valves within the cylinders.

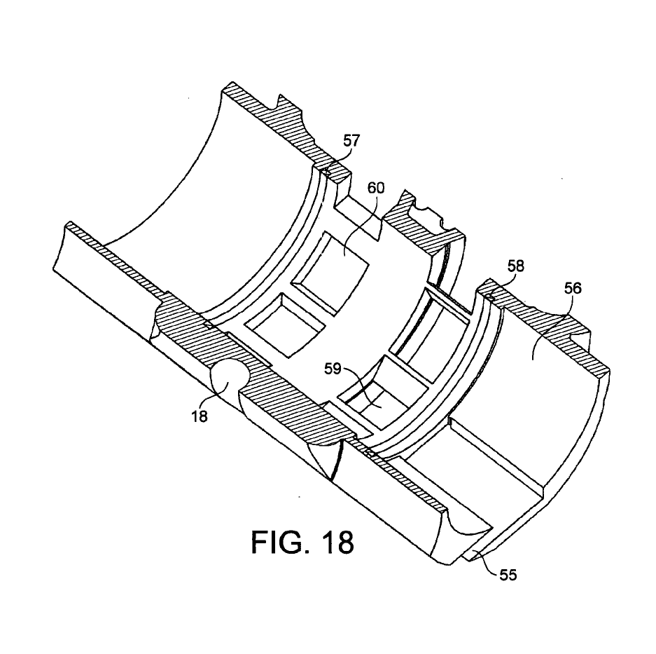

Each cylinder is provided with a pair of oil scraper rings 57, 58. The oil scraper rings are positioned within a groove or channel in the internal surface of the cylinder wall. The stepped oil scraper rings are preferably positioned close to or immediately adjacent the step in the internal wall of the cylinder as shown in FIG. 18.

It will be appreciated that the piston rings 25 and scraper ring 26 of the pistons 24 form a seal with the interior surface of the sleeve valves and that the scraper rings in the cylinder wall form a seal between the exterior surface of the sleeve valves and the interior surface the cylinder wall. A result of this configuration is that contact between the piston rings and the intake and exhaust ports is prevented. This may serve to reduce or eliminate any loss of fuel from the combustion space and/or loss of oil from behind the pistons out through the exhaust ports.

Each cylinder includes a cutaway or notch 18 for receiving bolts which pass from the induction side casing to the exhaust side casing section. The bolts locate the cylinders and prevent lateral and/or rotational motion of the cylinders within the casing. As will be described further below, a series of flanges around the external wall of the cylinders define discrete, sealed, passages for the flow of air entering the cylinders, for the flow of exhaust products being scavenged from the cylinder and for a coolant to circulate.

A plurality of intake 59 and/or exhaust ports 60 is provided through the wall of each of the cylinders. The ports of each of the plurality of ports are evenly spaced around the circumference of the cylinders and centred on the same plane which is transverse to the axis of reciprocation of the pistons. The ports of each of the plurality of ports are spaced from one another around the circumference of the cylinders by bridge portions 61. The bridge portions which dividing the intake ports are preferably angled to form vanes in order to promote swirl and create turbulent flow in the cylinder. As described further below, an air intake plenum is formed around, and delivers charging air to, the plurality of intake ports and an exhaust plenum is formed around, and carries the combustion products away from, the plurality of exhaust ports. The air intake plenum includes a flow divider for directing air towards the plurality of intake ports through the wall of each cylinder. Alternatively, a separate intake plenum may be provided for each cylinder.

The cumulative total port area of the plurality of intake ports is preferably about the same as the area of the crown of one of the piston and the cumulative total port area of the plurality of exhaust ports is about the same as the area of the crown of one of the pistons.

In each cylinder, the plurality of intake ports 59 is provided through the cylinder wall between the TDC and BDC positions of one of the opposed pair of sleeve valves and the plurality of exhaust ports 60 is provided through the cylinder wall between the TDC and BDC positions of the other of the opposed pair of sleeve valves. The plurality of intake and exhaust ports are therefore spaced from one another along the length of each cylinder. The intake and exhaust ports are positioned on opposite sides of a transverse centreline of the engine so that porting of the intake ports is controlled by one of the sleeve valves of each opposed pair of sleeve valves 33, 34—an intake sleeve valve—and porting of the exhaust ports is controlled by the other of the sleeve valves of each opposed pair of sleeve valves 35, 36—an exhaust sleeve valve.

As shown in FIGS. 8 and 9, the central drive assembly is arranged so that for each piston and its respective sleeve valve, an axis along which the sleeve valve driving arm reciprocates is spaced from, and parallel to, an axis on which the piston rod assembly reciprocates. Furthermore, the axis of reciprocation the sleeve valve driving arm is positioned around the circumference of the shaft 20a from the axis of reciprocation of the piston rod assembly. This means that for each piston and its respective sleeve valve, an axis of reciprocation along which the followers 45, 46 coupled to the sleeve valve driving arm reciprocate is positioned around the circumference of the shaft from an axis of reciprocation on which the followers 28, 29 coupled to the piston rod assembly 27 reciprocate. Preferably, for each piston and its respective sleeve valve, an axis of reciprocation of the sleeve valve driving arm followers is about 90 degrees around the circumference of the shaft the axis of reciprocation of the piston rod assembly followers. This provides a configuration in which the sleeve valve driving arm of the sleeve valve reciprocates in the space to one side of the shaft, between the two cylinders.

This offset configuration makes optimum use of the space available in the engine and may enable a reduction in one or more of the following dimensions of the engine: the length of the shaft 20a between the intake sleeve valve cam 38 and the exhaust sleeve valve cam 37; the length of the shaft 20a between the piston cams 21, 22; the overall length of the shaft 20a ; the length of the cylinders 19, 20; the length of the pistons 34. Any or all of these may lead to a corresponding reduction in the physical size of the engine and/or the weight of components forming part of the engine including any or all of the pistons, the shaft and the casing, among others.

Preferably, the central drive assembly 17 is also arranged so that a plane on which sleeve valve driving arm reciprocates is substantially orthogonal to a plane on which the piston rod assembly reciprocates.

In the two cylinder opposed piston version of the engine shown in the various Figures, the central drive assembly is arranged so that:
(i) the sleeve valve driving arm 41 of a sleeve valve 33 at a first end of a first cylinder 19 is positioned on a diametrically opposite side of the shaft 20a from the sleeve valve driving arm 39 of the sleeve valve 35 at the first end of the second cylinder 20;
(ii) the sleeve valve driving arm 41 of the sleeve valve 33 at a first end of a first cylinder 19 is positioned on a diametrically opposite side of the shaft 20a from the sleeve valve driving arm 42 of the sleeve valve 36 at the second end of the first cylinder 20.

This configuration may help to provide a more inherently balanced engine.

The axial cams 21, 22 may be shaped to induce at least one period of dwell of each of the pistons during their respective cycles of piston movement. In particular, the profile of the axial piston cams is such that each piston is subjected to a period of dwell in its BDC position. The axial piston cams may also be profiled so as to subject each piston to a period of dwell in its TDC position. The duration of the period of dwell of the pistons in their respective TDC and/or BDC position is determined by the profile of the axial cams. The cams may be profiled to: define an appropriate dwell period for a particular application; provide desired engine operating characteristics; optimise the engine for operation in a particular environment; optimise the engine for using a particular type and/or quality of fuel; or any combination of the above.

If the axial piston and/or sleeve valve cams are provided with a spline for engagement with a corresponding spline on the shaft, the engine may be modified after initial manufacture to substitute an axial cam having a first profile with an axial cam having a second, different, cam profile, for example defining a different period of dwell of the pistons/sleeve valves.

In a preferred embodiment, the axial cams are shaped so that the pistons undergo a period of dwell in their respective BDC positions while the majority, or substantially all of the scavenging of the waste products of combustion through the at least one exhaust port occurs before the pistons begin to move from the BDC position towards the TDC position on the compression stroke. Preferably, the piston cams are shaped to provide a period of dwell of the pistons at BDC of between 60 and 140 degrees of shaft rotation. More preferably, the cams are shaped to provide a period of dwell of the pistons at BDC of about 100 degrees of shaft rotation.

In a preferred embodiment, the axial cams are shaped so that the pistons dwell in their respective TDC positions while substantially all of the heat exchange of combustion takes place in the cylinder at constant volume before the pistons begins to move away from their respective BDC positions on their expansion stroke. Preferably, the cams are shaped to provide a period of dwell of the pistons at TDC of between 20 and 60 degrees of shaft rotation. More preferably, the cams are shaped to provide a period of dwell of the pistons at TDC of about 40 degrees of shaft rotation.

The aforementioned preferred dwell periods represent a balance between a wide range of relevant factors and have been selected with the aim of maximising the volumetric efficiency of the engine. Alternative dwell periods will be suitable for an engine embodying the present invention and may be determined in relation to any or all of the following factors, among others: a particular application (e.g. where maximum power output or fuel efficiency is critical); a particular operating environment (e.g. where the ambient air temperature is particularly high or low); the availability of certain types and/or qualities of fuel.

As described above in relation to the axial piston cams 22, 23, the profile of the axial sleeve valve cams 37, 38 defines and controls the reciprocal motion of the sleeve valves 33, 34, 35, 36. The axial sleeve valve cams may, for example, be shaped so that the opposed sleeve valves in one of the cylinders 33, 34 are reciprocated in or out of phase with the opposed sleeve valves in the other of the cylinders 35, 36 or so that in each cylinder, the opposed sleeve valves are reciprocated in or out of phase with each other.

The sleeve valve driving mechanism is arranged to reciprocate each sleeve valve in the same direction as their respective piston but out of phase with reciprocal motion of the piston. This may be achieved by:- the shape of the axial sleeve valve cams; the axial sleeve valve cams being positioned further around the circumference of the shaft from the piston cams so that they are out of phase with the axial piston cams; a combination of the two.

The shaft 20a with piston and intake and exhaust sleeve valve cams is shown in more detail in FIGS. 10 to 14. In a preferred form of the invention, the axial piston cams 21, 22 are identical to and mirror images of one another and positioned in phase with one another on the shaft. Each of the axial sleeve valve cams 37, 38 has a cam profile which is different to the other and different to the cam profile of the axial piston cams 21, 22.

In an example form of an engine embodying the invention designed with a particular focus on optimising volumetric efficiency:
(i) the exhaust sleeve valve cam 38 is positioned about 20 degrees around the shaft from the piston cams 21, 22 so that the piston cams have about a 20 degree lead on the exhaust sleeve valve cam; and
(ii) the intake sleeve valve cam 37 is positioned about 40 degrees around the shaft from the piston cams 21, 22 so that the piston cams have about a 40 degree lead on the intake sleeve valve cam and the exhaust sleeve valve has about a 20 degree lead on the intake sleeve valve cam.

As shown in FIG. 24 and as described below in more detail, in an example form the engine designed with a particular focus on optimising volumetric efficiency, the cam profile of the axial sleeve valve cams is shaped such that the intake and exhaust sleeve valves, although continuously moving along the cylinders during their respective cycles of motion, only move a relatively small proportion of their respective sleeve valve stroke during the period of shaft rotation which includes: (i) the compression stroke of the pistons, (ii) the period of piston dwell at TDC and (iii) the expansion stroke of the pistons. However, the cam profile of the axial sleeve valve cams may be shaped so that either or both of the intake and exhaust sleeve valves is subjected to a period of dwell or a longer, or shorter, period of reduced linear movement, during the engine cycle than the period referred to above.

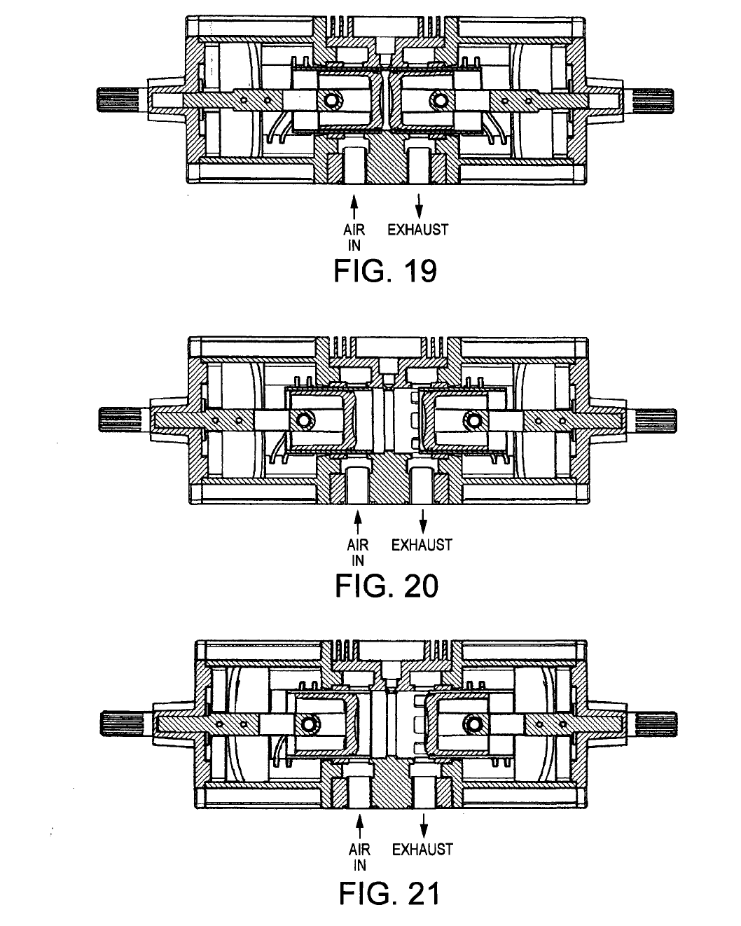

With reference to FIG. 24, the cam profile of each of the axial sleeve valve cams is preferably shaped so that any or any combination of the following apply:
(i) in each cylinder, one or both of the intake and exhaust sleeve valves is subjected to a period of continuous movement which approximates dwell during the cycle of sleeve valve motion;
(ii) in each cylinder, the intake sleeve valve moves about 20 per cent of its sleeve valve stroke in each direction (i.e. on each side of the TDC position of the intake sleeve valve curve of FIG. 19) over a period of between about 150 and about 250 degrees of rotation of the shaft, preferably about 195 degrees of rotation of the shaft;
(iii) in each cylinder, the intake sleeve valve approximates dwell for a period of between about 80 and about 150 degrees of rotation of the shaft, preferably about 115 degrees of rotation of the shaft. This is shown by a substantially flat portion of the intake sleeve valve curve of FIG. 24 which extends over the TDC position of the sleeve valve where, for example, the intake sleeve valve travels between about 5 and about 10 per cent of its sleeve valve stroke in each direction (i.e. on each side of the TDC position of the intake sleeve valve curve);
(iv) in each cylinder, the exhaust sleeve valve moves about 20 per cent of its sleeve valve stroke in each direction (i.e. on each side of the TDC position of the exhaust sleeve valve curve of FIG. 24) over a period of between about 150 and about 250 degrees of rotation of the shaft, preferably about 195 degrees of rotation of the shaft;
(v) in each cylinder, the exhaust sleeve valve approximates dwell for a period of between about 80 and about 150 degrees of rotation of the shaft, preferably about 110 degrees of rotation of the shaft. This is shown by a substantially flat portion of the exhaust sleeve valve curve of FIG. 24 which extends over the TDC position of the sleeve valve where, for example, the exhaust sleeve valve travels between about 5 and about 10 per cent of its sleeve valve stroke in each direction (i.e. on each side of the TDC position of the exhaust sleeve valve curve);
(vi) in each cylinder, the majority, or substantially all, of the stroke of each of the intake and exhaust sleeve valves is travelled during the period of dwell of the pistons in their respective BDC positions;

(vii) in each cylinder, each of the intake and exhaust sleeve valves remain substantially adjacent one another in their respective TDC positions so as to form a sealed combustion chamber for a period of shaft rotation which is at least as long as and which includes, the period of shaft rotation during which the pistons dwell in their respective TDC positions.
(viii) in each cylinder, each of the intake and exhaust sleeve valves remain substantially adjacent one another in their respective TDC positions forming a combustion chamber for a period of shaft rotation which is longer than the period of shaft rotation during which the pistons dwell in their respective TDC positions.

The engine casing may be made from an Aluminium alloy or cast iron. The pistons 24 may, for example, be made from an aluminium alloy, for example a silicon aluminium alloy or a high silicon, low expansion, piston alloy. The sleeve valves 33, 34, 35, 36 may, for example, be made from a high tensile or maraging steel, a hardened and ground steel, a coated aluminium alloy, or hard plated bronze. The shaft 20a may, for example, be made from high tensile steel, for example EN24T which may be tempered for machining. The axial piston 21, 22 and sleeve valve cams 37, 38 may, for example, be made from hardened steel or chilled cast iron. The cam followers 28, 29, 45, 46 rotatably supported by the piston rod assembly and by the sleeve valve driving arm may be made from silicon nitride, which may mean that there is little or no need for lubrication of the followers and the followers will resist deformation under point contact with the cam surfaces.

The shaft is preferably integrally formed with the axial piston cams and axial sleeve valve cams. Alternatively, the shaft may be machined from a solid billet to form the axial piston cams and axial sleeve valve cams.

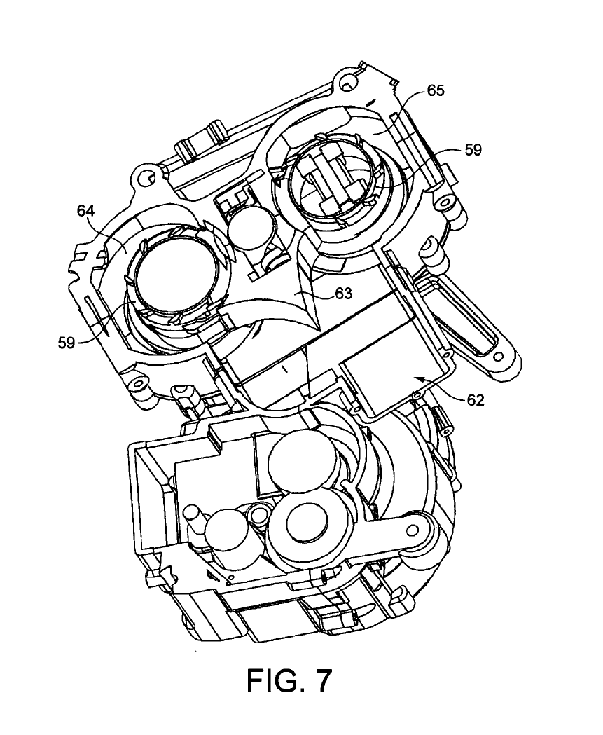

With reference to FIG. 7, charging air enters the engine through an air intake 62 and is divided by flow a diverter 63. The diverted streams of air are then channelled into an intake plenum for each cylinder 64, 65. The intake plenums formed by flanges extending from an exterior surface of the cylinders around the pluralities of intake ports. The angled bridge portions 61 between the intake ports causes the charging air to swirl promoting turbulent flow.

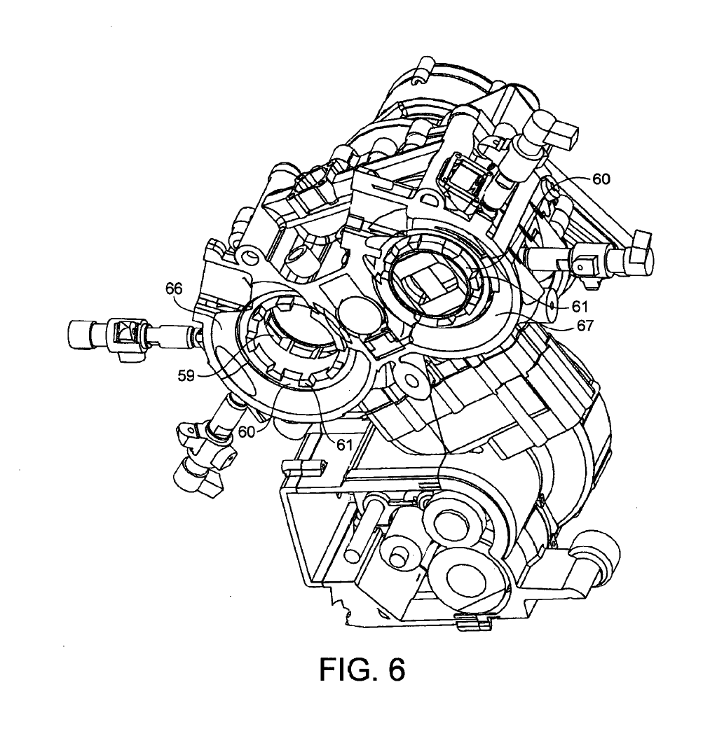

With reference to FIG. 6, the products of combustion pass out through the exhaust ports into exhaust plenums 66, 67. The exhaust plenums are formed by flanges extending from an exterior surface of the cylinder around the pluralities of exhaust ports. The exhaust plenums lead to exhaust egresses 68, 69 which may be connected to an exhaust system (not shown).

The engine may be scavenged by compressed air only, fuel being injected after the exhaust ports are closed by the exhaust sleeve valves. This may be achieved, for example, by an exhaust driven turbo-compressor, a separate scavenging pump or a combination of the two.

A split or bifurcated intake tract (not shown) may be provided whereby scavenging air for forcing the waste products of combustion from the cylinder through the exhaust ports is supplied from one source and fresh charging air for the next combustion event in the cylinders may be provided from an alternative source. Pressurised scavenging air may, for example, be provided from a pressurised storage reservoir or directly from an electrically or mechanically driven pump or compressor. Pressurised charging air may be provided by means of a pressurised storage reservoir exhaust-driven turbocharger or similar device to increase the flow rate of air into the cylinders. By utilising an exhaust pressure driven compressor to provide charge compression, excess exhaust energy may be converted to useful work and the requirement for the piston to do the work of charge compression is reduced, which may result in higher overall engine efficiency.

A pair of injectors 70, 71, and 72, 73 coupled to a fuel injection system is provided for injecting fuel into a combustion space defined between the pistons crowns of the opposed pistons in each cylinder. The duration of the fuel injection events can be accurately controlled and varied depending on factors such as engine speed and the load on the engine. This may be achieved using an electronically-controlled common rail fuel system. Fuel injection may be accomplished, for example, by means of the patented “Orbital” injection system.

It may be beneficial to inject one or more of fuel, water, methanol or diesel at an appropriate point during the engine cycle to control the combustion process. It may also be beneficial to inject additional fuel during, or just after, the period of dwell of the pistons in their TDC positions so that fuel continues to be burned during the expansion stroke of the pistons.

Ignition may be achieved by means of Homogeneous Charge Compression Ignition (HCCI) or “Smartplugs”, (a plasma injection device). Both of these allow for ultra-lean mixtures to be burned.

A sump (not shown) is provided for storing lubricating oil. Oil is circulated by a pump through oil passageways within the cylinder block and appropriate drillings in the shaft in order to lubricate the various rotating components of the engine. Lubrication of the sleeve valve may be achieved by pressure lubrication from oil feed holes in the engine block casing mating with fine grooves machined on the outside walls of the cylinder liner.

Oil injection holes 74, 75, 76, 77 may be provided at each end of the cylinders through which oil is injected under pressure towards the underside of the pistons. Oil collection ports 78, 79 are also provided for draining excess oil from the cylinders.

The engine may include a cooling system comprising internal passageways through which a coolant may be circulated by a pump. Passageways may be formed between flanges projecting from an exterior surface of the cylinders which form a seal with an interior surface of the engine casing. Three such channels 80, 81, 82 may be formed around each of the cylinders, one around the centre of the cylinder around the combustion space and one around each end of the cylinders. Suitable linking passages are provided so as to allow a coolant to circulate between the various channels around the cylinder. The passageway around the combustion space in the centre of the cylinder may be provided with one or more throttling 83 devices for diverting the flow of a coolant. The injectors protrude through the throttling device into the combustion space in order to prevent contact with the coolant.

The engine may have other conventional components and systems that are not shown in the Figures, for example, any or all of the following may be provided or required: a starter motor and flywheel assembly; an oil sump and oil circulation system; a high pressure fuel system; an air intake and filtering system; induction manifold(s) for directing air to the cylinders; exhaust manifold(s) for removing the waste products of combustion from the cylinders; an exhaust pipe with silencer for releasing the waste products of combustion to the atmosphere; a drive for a turbocharger or supercharger; an ignition system where the engine relates to a spark ignition engine.

Operation of the engine described above with reference to the various figures will now be described.

Fuel is injected by the injector(s) into the combustion space defined by the sleeve valves and the opposed piston crowns in the first of the cylinders. Combustion of the fuel in the cylinder preferably occurs at the TDC of the pistons and during a period of piston dwell of about 40 degrees of shaft rotation (during which the pistons are undergoing dwell in their respective TDC positions) so that flame propagation through the fuel/air mixture in the combustion chamber occurs during while the opposed pistons dwell at TDC. The effect of this is that all or substantially all of the heat exchange of combustion may occur at TDC constant volume.

At the end of the period of TDC dwell of the pistons, the pistons in the first cylinder begin to move outwardly along their expansion stroke towards their respective BDC positions. Movement of the pistons in the first cylinder causes movement of the associated piston rods and the followers on the piston rods engage with the cam surfaces of the axial piston cams to cause rotary motion of the axial piston cams. Rotary motion of the axial piston cams rotate the shaft which imparts reciprocal motion to the opposed pistons in the second cylinder via their respective followers and piston rod assemblies causing them to advance in the opposite direction to the pistons in the first cylinder along their compression stroke towards their TDC positions.

Rotary motion of the shaft also causes rotary motion of the axial sleeve valve cams which imparts linear motion to the sleeve valves via the followers coupled to the sleeve valve driving arms. Linear motion of the sleeve valves controls porting of the plurality of intake and exhaust ports as discussed further below.

As the pistons in the first cylinder 6 reach their respective BDC positions at the end of the expansion stroke, about 110 degrees of shaft rotation after the pistons begin to move from their TDC position, the pistons are subjected by the axial cams of the dwell mechanism to a further period of dwell in their BDC position of about 100 degrees of shaft rotation. The pistons in the second cylinder also reach their respective TDC positions at the end of their compression stroke. During this period of dwell of the pistons in the second cylinder at BDC, the waste products of combustion are scavenged from the cylinder through the exhaust ports 43 which have been opened by the exhaust sleeve valve.

At the end of the period of piston dwell at BDC, the pistons in the first cylinder are advanced on their expansion stroke towards their respective TDC positions along the compression stroke by the axial cams that are being driven by movement of the pistons in the second cylinder along their expansion stroke. Porting of the intake and exhaust ports is again controlled by reciprocal motion of the sleeve valves induced by rotary motion of the shaft. Air enters the cylinder through the intake port(s) and is compressed between the opposed piston crowns as the pistons are advanced by the axial piston cams to their respective TDC positions, arriving about 110 degrees of shaft rotation after starting their compression stroke. The engine cycle then repeats.

FIGS. 19 to 22 show the effect of reciprocation of the sleeve valves on the engine porting. In the FIG. 19 position, the pistons in the first cylinder are both in their TDC position at the midpoint of the dwell period. Their respective sleeve valves are at, or very close to, their TDC position in which they abut or substantially abut each other or a shoulder in the cylinder wall so as to define the combustion chamber. The intake and exhaust ports in the cylinder walls both remain closed by the respective intake and exhaust sleeve valves. In this position, air cannot enter the cylinder and the combustion products cannot leave the cylinder. Combustion of the fuel/air mixture therefore occurs at constant volume.

After a period of dwell of the pistons of about 40 degrees of shaft rotation, the pistons set off along their expansion stroke towards their respective BDC positions. The profiles of the axial piston cams and the axial sleeve valve cams and/or their relative positions on the shaft are such that there is a time lag between movement of the pistons along their expansion stroke and corresponding movement of the intake and exhaust sleeve valves. As shown in FIG. 24, the timing of the piston and sleeve valve movement is such that the exhaust sleeve valve begins to open the exhaust ports substantially as, or just after the pistons arrive at BDC. The exhaust sleeve valve accelerates rapidly so the exhaust ports are fully opened by the exhaust sleeve valve in the early part of the BDC piston dwell period of about 130 degrees of shaft rotation. The timing of the intake sleeve valve movement is such that the intake sleeve valve accelerates more slowly than the exhaust sleeve valve and at a similar rate to the pistons as it moves towards its BDC position. The intake sleeve valve arrives at its BDC position substantially as the pistons begin to move away from their BDC positions on their compression stroke.

In the FIG. 20 position, the pistons in one of the cylinders are both in their respective BDC positions and at, or near, the midpoint of their BDC dwell period. The exhaust sleeve valve has moved away from its TDC position towards its BDC position so as to partially open the exhaust ports and allow scavenging of the combustion products from the engine. The axial sleeve valve cams are configured so that movement of the intake sleeve valve is out of phase with movement of the exhaust sleeve valve and there is a time lag between movement of the exhaust and intake sleeve valves. The intake sleeve valve has begun to move away from its TDC position towards its BDC position but has not travelled as far along the cylinder as the exhaust sleeve valve. The inner edge of the intake sleeve valve has not yet passed the inner edge of the intake ports and so the intake ports remain fully closed.

In the FIG. 21 position, the pistons in one of the cylinders remain in their respective BDC positions during the period of dwell of the pistons. The exhaust sleeve valve has reached its BDC position, opening the exhaust ports and allowing further scavenging of the combustion products from the engine. About 20 degrees of shaft rotation after the exhaust sleeve valve begun to open the exhaust valves, the intake sleeve valve has partially opened the intake ports allowing air to enter the cylinder. Air entering the cylinder under pressure assists with the scavenging process by forcing the combustion products through the exhaust port.

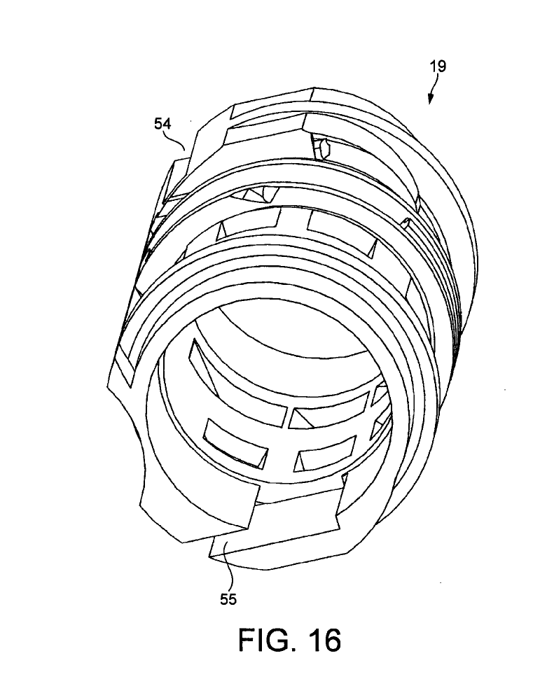

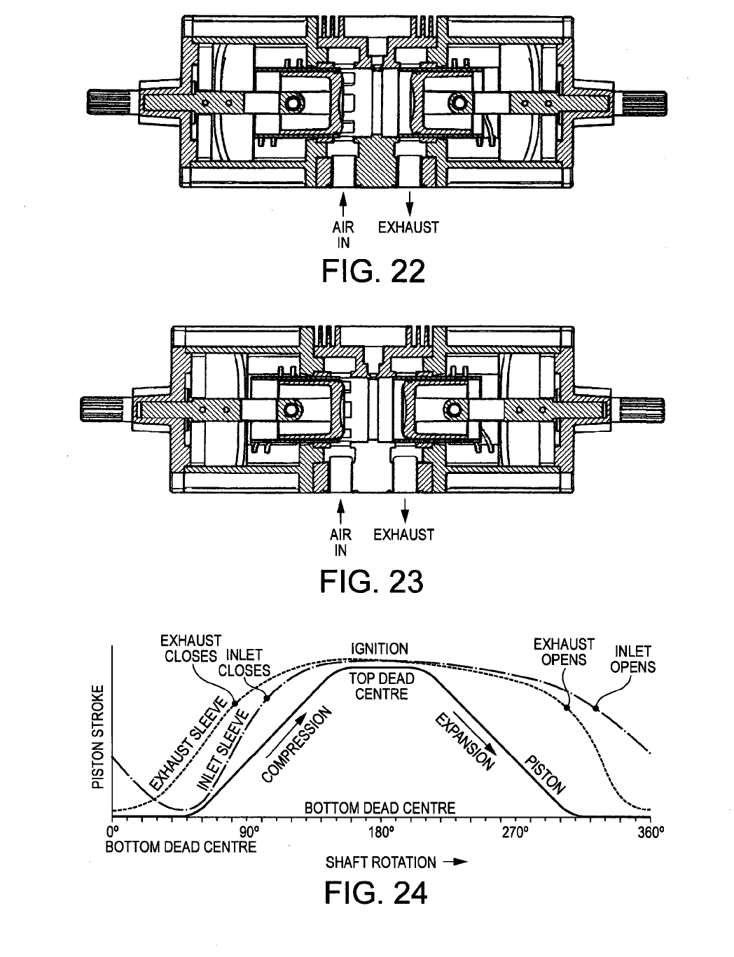

In the FIG. 22 position, the pistons in the first cylinder are about to set off along their compression stroke towards their respective TDC positions. The intake sleeve valve is at its BDC position and also about to set off towards its TDC position so as to close the intake ports. The exhaust sleeve valve is moving from the BDC position of FIG. 16 towards the TDC position to close the exhaust ports. Air entering the cylinder continues to assist with scavenging of the waste products from the cylinder.

In the FIG. 23 position, the pistons in the first cylinder continue to move along their compression stroke towards their TDC positions. About 30 degrees of shaft rotation after the pistons leave their TDC positions, the exhaust sleeve valve has fully closed the exhaust port. The intake sleeve valve has begun to close the intake ports but the intake ports are still partially open. Therefore, compressed air is still entering the cylinder but is no longer replacing the combustion products leaving the cylinder as the exhaust port has been closed. The compressed air entering the cylinder is compressed between the opposed piston crowns as the pistons move towards their respective TDC positions. About 20 degrees of shaft rotation after the exhaust sleeve valve closes the exhaust ports, the intake ports are fully closed by the intake sleeve valve.

The intake 29 and exhaust 30 sleeve valves accelerate past their respective pistons as the pistons advance towards TDC so that the sleeve valves arrive at their TDC positions to define and seal the combustion chamber shortly before the pistons arrive at TDC as shown in FIG. 19.

It will be appreciated from the foregoing and with particular reference to FIG. 24, that the majority of the reciprocal movement of the exhaust sleeve valve and the intake sleeve valve occurs during the period of dwell of the pistons in their BDC positions and that only a relatively small percentage of the stroke of the intake and exhaust sleeve valves is covered during the period of shaft rotation comprising the second half of the piston movement on the compression stroke, the piston dwell period at TDC and the first half of the piston movement on the expansion stroke.

The axial cam profiles of the cams which drive the intake and exhaust sleeve valves is likely to be a balance between the period of shaft rotation during which the intake and/or exhaust sleeve valve dwells or is subject to a period of reduced linear motion, thereby approximating dwell, and the peak acceleration of the sleeve valves in moving between their respective TDC and BDC positions.

By timing the exhaust sleeve valve to open the exhaust ports as, or just before, the pistons arrive at BDC, the pistons undergo a complete expansion stroke before the exhaust ports are opened and the combustion products start to be scavenged from the cylinder. This may improve the efficiency of known engines in which the exhaust ports are opened early by the pistons on their expansion stroke.

By timing the exhaust sleeve valve to close the exhaust ports fully during the compression stroke of the pistons after the BDC piston dwell period, the exhaust ports remain open for the entirety of the piston dwell period at BDC. This may provide significantly more time for scavenging of the combustion products than in known engines in which there is no dwell of the pistons.

By timing the exhaust sleeve valve to begin to open the exhaust ports about 20 degrees of shaft rotation before the intake sleeve valve starts to open the exhaust ports, a period of the engine cycle is provided for blowdown to occur. This may allow additional time for the cylinder pressure to drop below the scavenging air pressure.

By timing the intake sleeve valve to open the intake ports during the early stages of the piston dwell period at BDC and to open the intake ports fully during the compression stroke of the pistons, the intake ports can remain open for a significant proportion of the engine cycle. This may allow additional time for more complete charging of the cylinder before the intake ports are closed.

By timing the intake sleeve valve to fully close the intake ports about 20 degrees of shaft rotation after the exhaust sleeve valve fully closes the exhaust ports, the engine may allow for a period of charge compression or ‘supercharging’ of the air entering the cylinders.

The axial sleeve valve cams are shaped so that the exhaust ports remain at least partially open for about 140 degrees of rotation of the shaft and the intake ports remain at least partially open for about 140 degrees of rotation of the shaft. As such, the intake and exhaust ports can remain at least partially open for a substantial portion of the engine cycle.

The axial sleeve valve cams are also shaped so that the exhaust ports and the intake ports are both at least partially open for an overlapping period of about 120 degrees of rotation of the shaft. As such, over a substantial portion of the engine cycle, air entering the cylinder can assist with scavenging of the cylinder, enhancing the flow of air through the engine.

All numeric values in the preceding description are provided by way of example only and are not intended to limit the scope of the claims. The example values of shaft rotation in the preceding description relate to one particular form of the invention designed primarily for optimum volumetric efficiency. The skilled person will readily appreciate that alternative values of shaft rotation will be appropriate for a modified version of the engine designed with one or more other key factors in mind, for example, maximum power density, operation using fuels of a particular type or grade, among others.

It will be appreciated that while the above description relates to a preferred form of an engine being an opposed piston engine having a pair of cylinders in which a pair of pistons and respective sleeve valves reciprocate in an opposed manner, a number of other embodiments fall within the scope of the invention. For example, an engine embodying the invention may have fewer, or a greater number of, cylinders than the two cylinder version described above. An engine embodying the invention may be a single cylinder engine having only one reciprocating piston and sleeve valve or having a pair of pistons and sleeve valves which reciprocate in an opposed manner. An engine embodying the invention may alternatively comprise two cylinders, each one having only one reciprocating piston and sleeve valve. An engine embodying the invention may alternatively comprise more than two cylinders, each one having only one reciprocating piston and sleeve valve, or more than two cylinders each one having a pair of pistons and sleeve valves which reciprocate in an opposed manner. Other suitable configurations will be apparent to the skilled person.

1. An engine comprising:
at least one cylinder;
at least one piston reciprocatable within the at least one cylinder;
at least one intake port through a wall of the at least one cylinder;
at least one exhaust port through a wall of the at least one cylinder;
at least one reciprocatable sleeve valve within the at least one cylinder for controlling porting of one or both of the at least one intake port and the at least one exhaust port;
at least one shaft rotatable by reciprocal motion of the at least one piston;
a piston drive means coupled to and reciprocatable with the least one piston;
a sleeve valve drive means coupled to and reciprocatable with the at least one reciprocatable sleeve valve;
wherein an axis of reciprocation the sleeve valve drive means is positioned around the circumference of the at least one shaft from an axis of reciprocation of the piston drive means.

2. An engine according to claim 1, further comprising a piston driving mechanism for engaging with the piston drive means and converting reciprocal motion of the at least one piston to rotational motion of the at least one shaft.

3. An engine according to claim 1 or 2, further comprising a sleeve valve driving mechanism for engaging with the sleeve valve drive means to reciprocate the at least one sleeve valve.

4. An engine according to any of claims 1 to 3, configured so that reciprocal motion of the at least one sleeve valve is linked to reciprocal motion of the at least one piston.

5. An engine according to any of the preceding claims, configured so that the at least one sleeve valve is reciprocatable out of phase with the reciprocal motion of the at least one piston.

6. An engine according to any of claims 2 to 5, wherein the piston driving mechanism comprises a first cam mechanism comprising at least one piston cam.

7. An engine according to claim of claims 3 to 6, wherein the sleeve valve driving mechanism comprises a second cam mechanism comprising at least one sleeve valve cam.

8. An engine according to claim 6 or 7, wherein the at least one piston cam comprises an axial cam.

9. An engine according to claim 7 or 8, wherein at least one sleeve valve cam comprises an axial cam.

10. An engine according to any of the preceding claims, wherein the piston drive means comprises a piston rod assembly which extends from the at least one piston.

11. An engine according to claim 10, wherein the piston rod assembly supports a first pair of cam followers.

12. An engine according to any of the preceding claims, wherein the sleeve valve drive means comprises a sleeve valve driving arm which extends from the at least one reciprocatable sleeve valve.

13. An engine according claim 12, wherein the at least one sleeve valve comprises a flange around an end of the sleeve valve and the sleeve valve driving arm extends from the flange.

14. An engine according to claim 12 or 13, wherein at least a portion of the sleeve valve driving arm comprises a substantially flat plate.

15. An engine according to any of claims 12 to 14, wherein the sleeve valve driving arm supports a second pair of cam followers.

16. An engine according to any of claims 12 to 15, wherein the sleeve valve driving arm slideably engages with a slot in the at least one cylinder.

17. An engine according to any of claims 6 to 16, wherein the at least one piston cam is located on the at least one shaft.

18. An engine according to any of claims 7 to 17, wherein the at least one sleeve valve cam is located on the at least one shaft.

19. An engine according to any of claims 6 to 18, wherein the at least one piston cam is configured to induce at least one period of dwell of the at least one piston during its cycle of piston motion.

20. An engine according to claim 19, wherein the at least one piston cam is configured to induce a period of dwell of the at least one piston in its BDC position during the cycle of piston motion.

21. An engine according to claim 20, wherein the period of dwell of the piston in its BDC position is sufficient for substantially all scavenging of the waste products of combustion through the at least one exhaust port to occur before the piston begins to move away from its BDC position.

22. An engine according to any of claims 19 to 21, wherein the at least one piston cam is configured to induce a period of dwell of the at least one piston in its TDC position during the cycle of piston motion.

23. An engine according to claim 22, wherein the period of dwell of the piston in its TDC position is sufficient for substantially all of the heat exchange of combustion to occur in the cylinder at constant volume before the piston begins to move away from its TDC position.

24. An engine according to any of claims 7 to 23, wherein the at least one sleeve valve cam is configured to induce at least one period of dwell of the at least one sleeve valve during its cycle of sleeve valve motion.

25. An engine according to claim 24, wherein the at least one sleeve valve cam is configured to induce a period of dwell of the at least one sleeve valve in its TDC position during the cycle of sleeve valve motion.

26. An engine according to claim 25, configured so that, in use, the at least one sleeve valve cam holds the at least one sleeve valve in its TDC position for a greater number of degrees of rotation of the shaft than the number of degrees of rotation of the shaft during which the at least one piston is held in its TDC position by the at least one axial sleeve valve cam.

27. An engine according to any of claims 7 to 25, wherein the at least one axial sleeve valve cam is configured to control porting of the at least one exhaust port and the engine is configured so that in use of the engine, the at least one exhaust port is opened by the at least one sleeve valve substantially as the at least one piston reaches its BDC position.

28. An engine according to any of claims 7 to 25, configured so that in use of the engine, the at least one exhaust port is opened by the exhaust sleeve valve after the piston reaches its BDC position.

29. An opposed piston engine according any of the preceding claims further comprising:
at least two pistons reciprocatable in an opposed manner within the at least one cylinder;
a piston drive means coupled to and reciprocatable with each of the least two pistons;
wherein the at least one shaft is rotatable by reciprocal motion of the at least two pistons; and
wherein an axis of reciprocation the sleeve valve drive means is positioned around the circumference of the at least one shaft from an axis of reciprocation of the piston drive means of at least one of the at least two pistons.

30. An opposed piston engine according to claim 29, wherein the axis of reciprocation the sleeve valve drive means is positioned around the circumference of the at least one shaft from the axis of reciprocation of the piston drive means of each of the least two pistons.

31. An opposed piston engine according to claims 29 to 30, wherein an axis of reciprocation of the piston drive means of a first one of the at least two pistons is positioned around the circumference of the at least one shaft from the piston drive means of a second one of the at least two pistons.

32. An opposed piston engine according to claim 31, wherein an axis of reciprocation of the sleeve valve drive means is positioned around the circumference of the at least one shaft from and between the respective axes of reciprocation of the respective piston drive means of the first and second pistons.

33. An opposed piston engine according to any of claims 29 to 32, wherein the at least two pistons are reciprocatable linearly and coaxially.

34. An opposed piston engine according to any of claims 29 to 33, wherein the at least two pistons are reciprocatable in a synchronous manner.

35. An opposed piston engine according to any of claims 29 to 34, further comprising at least two sleeve valves positioned within the same cylinder, one sleeve valve surrounding each of the at least two pistons, the sleeve valves being reciprocatable in an opposed manner within the at least one cylinder.

36. An opposed piston engine according to claim 36, wherein the at least two sleeve valves are reciprocatable linearly, coaxially, and coaxially with the at least two pistons.

37. An opposed piston engine according to claim 35 or 36, wherein the at least two sleeve valves are reciprocatable out of phase with one another.

38. An opposed piston engine according to any of claims 35 to 37, wherein the at least two sleeve valves are reciprocatable out of phase of their respective piston.

39. An opposed piston engine according to any of claims 35 to 38, wherein a first one of the at least two sleeve valves is arranged to control the porting of the at least one intake port and a second one of the at least two sleeve valves is arranged to control the porting of the at least one exhaust port.

40. An opposed piston engine according to any of claims 35 to 39, wherein a plurality of intake ports is provided through the wall of the at least one cylinder at a location between the TDC and BDC positions of the first sleeve valve and a plurality of exhaust ports is provided through the cylinder wall at a location between the TDC and BDC positions of the second sleeve valve.

41. An opposed piston engine comprising:
at least one cylinder;
at least two pistons reciprocatable within the at least one cylinder;
at least one intake port through a wall of the at least one cylinder;
at least one exhaust port through a wall of the at least one cylinder;
at least one reciprocatable sleeve valve within the at least one cylinder for controlling porting of one or both of the at least one intake port and the at least one exhaust port;
at least one shaft rotatable by reciprocal motion of the at least two pistons;
a piston drive means coupled to and reciprocatable with each of the at least two pistons;
a sleeve valve drive means coupled to and reciprocatable with the at least one reciprocatable sleeve valve;
wherein an axis of reciprocation the sleeve valve drive means is positioned around the circumference of the at least one shaft from an axis of reciprocation of the piston drive means of each of the at least two pistons.

42. An engine according to any of the preceding claims, wherein an axis of reciprocation the sleeve valve drive means is spaced from and parallel to an axis of reciprocation of the piston drive means of the or each piston.

43. An engine according to any of the preceding claims, wherein the, or at least one of, the reciprocatable sleeve valves is a continuous, non-ported, sleeve valve.

44. An engine according to any of the preceding claims, further comprising at least one oil scraper ring embedded within the wall of the cylinder which sealingly engages with the at least one reciprocatable sleeve valve.

45. An engine according to any of the preceding claims, wherein the at least one shaft is an output shaft for power take-off.

46. An engine according to any of the preceding claims, wherein the engine operates a two stroke cycle.

47. An engine according to any of the preceding claims, wherein the engine comprises a compression ignition engine.

48. An engine according to any of the preceding claims, wherein the engine comprises a first cylinder in which a first pair of pistons is arranged to reciprocate in an opposed manner and a second pair of opposed pistons in which a second pair of pistons is arranged to reciprocate in an opposed manner, wherein the at least one shaft is rotatable by reciprocal motion of the first and second pairs of opposed pistons and wherein the first and second cylinders are positioned on opposite side of the shaft.

49. An engine substantially as hereinbefore described with reference to the accompanying drawings.
